(19) United States
(12) Patent Application Publication
(10) Pub. No.: US 2022/0398526 A1
(43) Pub. Date: Dec. 15, 2022

(54) FULFILLMENT OF ORDERS SCHEDULED FOR AN IN-STORE PICKUP

(71) Applicant: Cognetry Labs Inc., Hillsboro, OR (US)

(72) Inventors: Balasubramanian Krishnamoorthy, Portland, OR (US); Muthukumar Udaiyanathan, Hillsboro, OR (US); Sandeep Sivanpillai Nair, Thiruvananthapuram (IN)

(21) Appl. No.: 17/339,734

(22) Filed: Jun. 4, 2021

(51) Int. Cl. G06Q 10/06; G06N 20/20; G06N 20/10; G06Q 10/08

(52) U.S. Cl. CPC G06Q 10/063114; G06Q 10/063112; G06Q 10/063116; G06N 20/20; G06N 20/10; G06Q 10/0836

(57) ABSTRACT

A system and method for order fulfillment is provided. A pickup timeslot in which a customer order is scheduled for pickup from a retail store is received along with order servicing constraints of human workers of the retail store. The customer order is divided into a set of suborders and one or more timeslots in which the set of suborders is to be serviced are determined based on the pickup timeslot and the order servicing constraints. A set of human workers available to work at the retail store within the one or more timeslots is identified and an optimization problem is solved to determine an assignment to service the set of suborders. The assignment maps the set of suborders to the set of human workers and is such that utilization of total hours available with the set of human workers to service the set of suborders is above a threshold.

### CROSS-REFERENCE TO RELATED APPLICATIONS/INCORPORATION BY REFERENCE

None.

### FIELD

Various embodiments of the disclosure relate to digital commerce. More specifically, various embodiments of the disclosure relate to a system and method of fulfillment of orders scheduled for in-store pickup.

### BACKGROUND

Advancements in digital commerce have led to an emergence of a large number of retail stores that accept orders online from customers. Such orders may typically be delivered at a delivery address of the customer or may be available for an in-store pickup at the retail store. After the order is placed or at the time of placing the order, the retail store may offer customers an option to pick up their orders from the retail store at certain pickup time or within a pickup time-window. Based on a pickup timeslot selected by a customer for pickup of his/her order from the retail store, the retail store may assign workers to service the order. Typically, the retail store may assign most efficient workers to service the order such that the order is serviced before the pickup timeslot selected by the customer. In some cases, this may lead to an underutilization of other workers or overutilization of efficient workers at the retail store. If required workers are unavailable at the required time for preparation of the order, then the fulfillment of the order may be affected with some delay. In some instances, even though the customer may arrive on time to pick up the order at the start of pickup slot, the customer may have to wait at the retail store for an extended period of time, which may affect the overall shopping experience of the customer.

Limitations and disadvantages of conventional and traditional approaches will become apparent to one of skill in the art, through comparison of described systems with some aspects of the present disclosure, as set forth in the remainder of the present application and with reference to the drawings.

### SUMMARY

A system and method of fulfillment of orders scheduled for in-store pickup is provided substantially as shown in, and/or described in connection with, at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 is a block diagram that illustrates an exemplary network environment for fulfillment of orders scheduled for in-store pickup, in accordance with an embodiment of the disclosure.

FIG. 2 is a block diagram that illustrates an exemplary system for fulfillment of orders scheduled for in-store pickup, in accordance with an embodiment of the disclosure.

FIG. 3 is a diagram that illustrates an exemplary processing pipeline for fulfillment of orders scheduled for in-store pickup, in accordance with an embodiment of the disclosure.

FIG. 4 is a diagram that illustrates an exemplary processing pipeline for determination of an assignment to service a set of suborders of a customer order, in accordance with an embodiment of the disclosure.

FIGS. 5A and 5B are diagrams that collectively illustrate an example scenario of assignment of a set of suborders of an order to a set of human workers of a retail store, in accordance with an embodiment of the disclosure.

FIG. 6 is a diagram that illustrates an example user-interface of a worker device, in accordance with an embodiment of the disclosure.

FIG. 7 is a diagram that illustrates an exemplary processing pipeline for training and use of a machine learning model for servicing time estimation, in accordance with an embodiment of the disclosure.

FIG. 8 is a diagram that illustrates another exemplary processing pipeline for training and use of a machine learning model for servicing time estimation, in accordance with an embodiment of the disclosure.

FIG. 9 is a flowchart that illustrates exemplary operations for fulfillment of orders scheduled for in-store pickup, in accordance with an embodiment of the disclosure.

### DETAILED DESCRIPTION

The described implementations may be found in the disclosed system and method for fulfillment of orders scheduled for in-store pickup. Exemplary aspects of the disclosure may include a system, such as, a cloud server, a group of cloud servers, a Software-as-a-Service (SaaS) application server, a distributed computing server, a mainframe system, a workstation, a personal computer, a mobile device, or any electronic computing-device. The system may receive a customer order from a customer device, such as a smartphone. The customer order may be for an in-store pickup of a set of items from a retail store. The system may further receive a pickup timeslot in which the customer order associated with the retail store may be scheduled for pickup from the retail store.

The system may receive order servicing constraints related to a group of human workers at the retail stores. For example, the order servicing constraints may include, but are not limited to, a number of human workers who may be available to work in timeslots within a first period (such as, a certain day, week, or month), and a number of hours each human worker works in a day. The system may divide the customer order into a set of suborders. For example, the system may receive inventory information related to items sold by the retail store. The customer order may be divided into the set of suborders based on the received inventory information. For example, the inventory information may include a database of items sold by the retail store. For each of the items, the database may include a unique product code or identifier, at least one of an item weight or an item volume, an item quantity, and a department of the retail store to which a respective item may belong.

The system may determine one or more timeslots in which the set of suborders may be serviced. The determination of the one or more timeslots may be based on the received pickup timeslot and the received order servicing constraints. The system may identify, from the group of human workers, a set of human workers who may be available to work at the retail store in the determined one or more timeslots. For example, the set of human workers who may be available for the determined one or more timeslots may be determined based on the order servicing constraints.

The system may solve an optimization problem to determine an assignment to service the set of suborders. The assignment may map the set of suborders to the identified set of human workers. Further, the determination of the assignment may be such that a utilization of total hours available with the set of human workers to service the set of suborders may be above a threshold.

The disclosed system may leverage the information related to resources available at the retail store and customer orders to determine the assignment to service the set of suborders of a customer order. The determined assignment may provide enough time to the workers at the retail store to prepare customer orders (before customers arrive at the pickup timeslots). Also, the determined assignment may optimize a total utilization of the human workers of the retail store. As the determined assignment may ensure that the suborders are timely serviced before the pickup timeslot, the pickup wait time for the customer at the store within the pickup timeslot may reduce. Thus, the disclosed system may enable the retail store to maximize resource utilization and service levels in an efficient manner. Since the customer may not have to wait for an extended period of time after the customer arrives at the store at the start of the pickup timeslot, the customer's shopping experience may be enhanced.

The disclosed system may also leverage historical order data (e.g., history of past 1000 customer orders or history of past 50 orders of an individual customer) of the retail store to train machine learning models and then use such trained models to estimate a servicing time duration for each suborder. While the system may initially rely on a median servicing time duration to determine the assignment for suborders, the estimation of the servicing time duration using machine learning models may help to determine more accurate assignment of suborders for human workers. Such an assignment may be more personalized for the human workers as the machine learning models consider the pickup data (included in the history of orders) of individual human workers of the retail store.

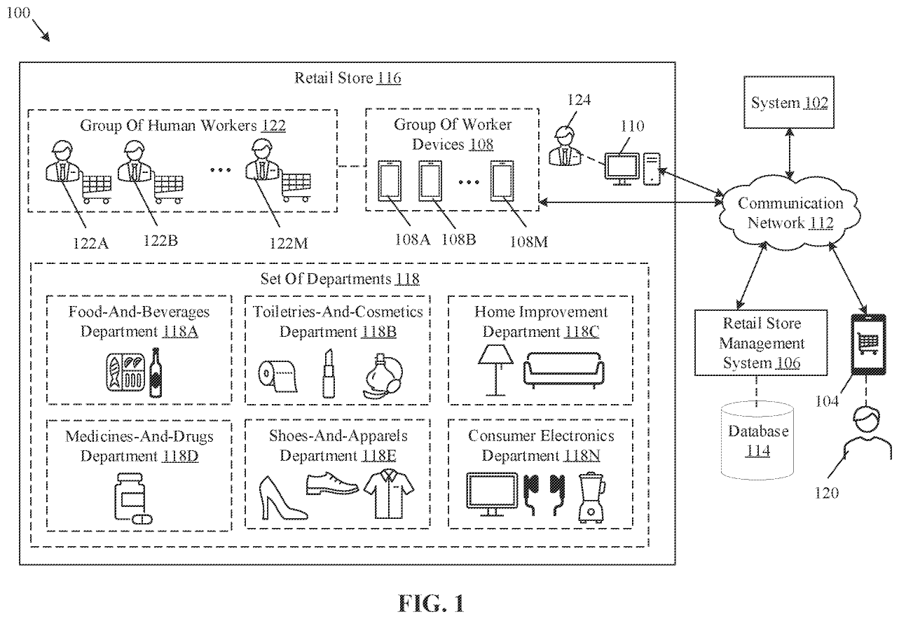

FIG. 1 is a block diagram that illustrates an exemplary network environment for fulfillment of orders scheduled for in-store pickup, in accordance with an embodiment of the disclosure. With reference to FIG. 1, there is shown a network environment 100. The network environment 100 may include a system 102, a customer device 104, a retail store management system 106, a group of worker devices 108, a store manager device 110, and a communication network 112. The group of worker devices 108 may include a first worker device 108A, a second worker device 108B . . . and an Mth worker device 108M. The retail store management system 106 may be associated with a database 114. The system 102 may be communicatively coupled to the customer device 104, the retail store management system 106, the group of worker devices 108, and the store manager device 110, via the communication network 112.

There is further shown a block diagram of a retail store 116. The retail store 116 may include a set of departments 118, such as, but not limited to, a food-and-beverages department 118A, a toiletries-and-cosmetics department 118B, a home improvement department 118C, a medicines-and-drugs department 118D, a shoes-and-apparels department 118E, . . . , and a consumer electronics department 118N. The set of departments 118 shown in FIG. 1 is presented merely as an example and should not be construed as limiting for the disclosure. The present disclosure may be applicable to other types of departments or sub-departments at a retail store. The description of other types of departments or sub-departments has been omitted from the disclosure for the sake of brevity. Also, the number of departments in FIG. 1 is presented merely as an example and should not be construed as limiting for the disclosure. The set of departments 118 may include more than or less than six departments, without departing from the scope of the disclosure.

The retail store 116 may be associated with a group of human workers 122. For example, the group of human workers 122 may be employed or contracted to work at the retail store 116 to service orders received by the retail store 116. The group of human workers 122 include a first human worker 122A, a second human worker 1228, and an Mth human worker 122M. Each of the group of human workers 122 may operate one or more worker devices (of the group of worker devices 108). For example, the first human worker 122A may operate the first worker device 1082A, the second human worker 1228 may operate the second worker device 108B, and the Mth human worker 122M may operate the Mth worker device 108M. The retail store 116 may be further associated with a store manager 124. The store manager 124 may be responsible for performing several tasks, such as, but not limited to, managing the day-to-day operations of the retail store, supervising the group of human workers 122, overseeing inventory, and ensuring targets set by the retail stores are achieved to a certain extent. The store manager 124 may operate the store manager device 110. There is further shown a customer 120 who may operate the customer device 104 to orders items at the retail store 116.

The system 102 may include suitable logic, circuitry, interfaces, and/or code that may be configured to determine an assignment to service a set of suborders of a customer order that may be picked up by the customer 120 in a certain pickup timeslot selected by the customer 120. The assignment may map the set of suborders of the customer order to a set of human workers from the group of human workers 122 at the retail store. Example implementations of the system 102 may include, but are not limited to, a cloud server (public, private, or hybrid), a distributed computing server or a cluster of servers, a Software-as-a-Service (SaaS) application server, an edge computing system that includes a network of distributed compute/edge nodes), a mainframe system, a workstation, a personal computer, or a mobile device.

In an exemplary embodiment, the system 102 may include a frontend subsystem and a backend subsystem. The frontend subsystem may be deployed on-premises or at a location of entities, such as retail stores (which may be registered with or connected to the system 102) and fulfillment centers (which may be associated with the retail stores or may operate independently). In an embodiment, the frontend subsystem may be a client-side application, accessible on worker devices, store manager devices, or on customer devices. The frontend subsystem may be configured to display a user interface (UI) which may include UI elements to allow customers, human workers, or store managers to provide inputs and view information related to orders or workers. The backend subsystem may include a server-side application, which may execute all instructions related to order scheduling and fulfillment for retail stores (registered with the system 102).

The customer device 104 may include suitable logic, circuitry, interfaces, and/or code that may be configured to enable a user (e.g., the customer 120) associated with the customer device 104 to place a customer order and to schedule the customer order for an in-store pickup at the retail store 116. In an embodiment, the customer device 104 may include a web client to access a client-side application or may include an installation of a software application. The client-side application or the software application may include a user interface for the customer 120 to execute several tasks, such as, but not limited to, to place the customer order at the retail store 116, interact with the staff at the retail store 116, schedule/select timeslots for the in-store pickup, or to track a status of the placed customer order. Through the client-side application on the web-client or the software application, the customer device 104 may display a set of timeslots to choose from for the in-store pickup of the customer order. Examples of the customer device 104 may include, but are not limited to, a kiosk device, a computer workstation, a personal computer, a mobile phone, a smartphone, a cellular phone, a tablet computing device, a gaming device, a server, a mainframe machine, a consumer electronic (CE) device, or any computing device with an inbuilt or installed web-client or a software application associated with the retail store 116.

The retail store management system 106 may include suitable logic, circuitry, interfaces, and/or code that may be configured to enable a management of operations of a retail store (e.g., the retail store 116) or a chain of retail stores. The retail store management system 106 may include a set of tools, such as, but not limited to, an inventory management system, a supply chain management system, a point-of-sale (PoS) management system, an order management system, an online marketing system, an e-commerce management system, an accounting management system, a customer relationship management (CRM) system, an enterprise resource planning (ERP) system, or a human resource (HR) management system. The retail store management system 106 may enable, for example, the retail store 116 to manage at least one of, but not limited to, an inventory of orders, customer orders, employee shifts/staffing, billing, and order preparation/fulfillment status of customer orders at with the retail store 116.

In an embodiment, the retail store management system 106 may be configured to use the database 114 to store information related to the retail store 116. Such information may be provided as a set of inputs to the system 102. The stored information may include, for example, order servicing constraints, inventory information, and the like. The stored information related to the set of inputs may further include a history of customer orders.

In one embodiment, the retail store management system 106 may be an on-premises system located at the facility of the retail store 116. In another embodiment, the retail store management system 106 may be located outside the retail store 116. For example, the retail store management system 106 may be an edge computing device, a fog-computing system (with at least one edge node located near the premises of the retail store 116), or a set of distributed computing devices. Alternatively, the retail store management system 106 may be a server (such as a cloud server). Other examples of the retail store management system 106 may include, but are not limited to, a SaaS application server, a database server, a distributed computing server, a mainframe system, a workstation, a personal computer, or a mobile device.

The group of worker devices 108 may include suitable logic, circuitry, interfaces, and/or code that may be configured to enable the group of human workers 122 to service the customer orders. In an embodiment, the group of worker devices 108 may include a web-client to access a client-side application or a pre-installed software application associated with the retail store 116. The client-side application or the software application may include a user-interface for human workers (e.g., the group of human workers 122) of the retail store 116. Through the web-client or the software application, each worker device (e.g., the first worker device 1082A) may receive a notification from the system 102 and/or the store manager device 110. The notification may include a schedule for the servicing the customer order and a set of instructions for the human worker (e.g., the first human worker 122A) to service the customer order or a sub-order thereof. Through the web-client or the software application, the worker device (e.g., the first worker device 1082A) may transmit a notification associated with the fulfillment of the customer order or a part of the customer order to the store manager device 110, the retail store management system 106 and/or the system 102. Examples of the group of worker devices 108 may include, but are not limited to, a kiosk device, a computer work-station, a personal computer, a mobile phone, a smartphone, a cellular phone, a tablet computing device, a gaming device, a server, a Point-of-Sale Device, a barcode reader, a mainframe machine, a consumer electronic (CE) device, or any computing device with capability to execute a web-client or a software application associated with the retail store 116.

The store manager device 110 may include suitable logic, circuitry, interfaces, and/or code that may be configured to display a user-interface, through which the store manager 124 may manage operations of the retail store 116. The operations of the retail store 116 may include, for example, assignment of tasks to the group of human workers 122 for servicing customer orders, order tracking, inventory management, sales, billing, logistics, customer relationship management, and the like.

In an embodiment, the store manager device 110 may include a web-client to access a client-side application or a pre-installed software application associated with the retail store 116. The client-side application or the software application may include the user-interface for the store manager 124 of the retail store 116. Through the web-client or the software application, the store manager device 110 may receive a notification related to customer orders. For example, the notification may be related to the customer orders which may be placed at the retail store 116 within a specific period (for example, last 5 days) and are yet to be serviced or fulfilled. The notification may include details of the customer order and a schedule for the pickup of the customer order. Additionally, the notification may include a timeslot (and/or a servicing time) in which the customer order (or its suborders) can be serviced before the pickup schedule. Based on the received notification, the store manager device 110 may transmit a set of instructions associated with servicing of the customer order to one or more devices of the group of worker devices 108. Examples of the store manager device 110 may include, but are not limited to, a kiosk device, a computer workstation, a personal computer, a mobile phone, a smartphone, a cellular phone, a tablet computing device, a gaming device, a server, a mainframe machine, a consumer electronic (CE) device, or any computing device with capability to execute a web-client or a software application associated with the retail store 116.

The database 114 may be configured to store the information related to, for example, the retail store 116, customers of the retail store 116, and customer orders placed at the retail store 116. Such information may be used to provide a set of inputs to the system 102. The database 114 may be a relational or a non-relational database. The database 114 may be stored on a device, such as the retail store management system 106, the system 102, or a server different from the retail store management system 106 and the system 102. The device which stores the database 114 may be configured to receive a request from the system 102, through the communication network 112, Based on the received request, the device may be configured to retrieve the set of inputs from the database 114 and may transmit the set of inputs to the system 102, through the communication network 112.

The retail store 116 may be a physical store that may operate according to a BOPIS system (i.e., Buy Online, Pick-up in Store). For example, the retail store 116 may list items (which may include goods, services, or a combination thereof) available for sale at the retail store 116 (or at its warehouses or nearby stores chains), on a website, a web application, or a software application (such as a mobile application or a desktop application). The website or the web application may be accessed via a web-client and the software application may be installed on various customer devices. In addition to the BOPIS system, the retail store 116 may operate according to other methods, such as buy online and get home delivery of orders. For example, a customer may choose to receive items in the customer order through a physical delivery option or an in-store pickup option. If the customer chooses the physical delivery option, one or more items purchased by the customer (such as the customer 120) may be shipped to the delivery address associated with the customer. If the customer chooses the in-store pickup option, the customer order may be prepared and provided to the customer at a physical location associated with the retail store 116. The physical location may be a location (such as a checkout counter or a drive through counter) within the premises of the retail store 116. Additionally, or alternatively, the physical location may include a set of parking spots at the retail store 116 or designated spots reserved by the retail store 116 for pick-up of serviced orders. In some instances, the retail store 116 may allow customers to add more items to a serviced customer order, while visiting the retail store 116 to pick-up the items of a serviced customer order.

The retail store 116 may be organized into different departments that may include one or more sub-departments for efficient servicing of the customer orders. For example, as shown in FIG. 1, the retail store 116 may include the set of departments 118, such as, but not limited to, the food-and-beverages department 118A, the toiletries-and-cosmetics department 1188, the home improvement department 118C, the medicines-and-drugs department 118D, the shoes-and-apparels department 118E, . . . , and the consumer electronics department 118N.

The communication network 112 may include a communication medium through which the system 102 may be communicatively coupled to the customer device 104, the retail store management system 106, the group of worker devices 108, and the store manager device 110. Examples of the communication network 112 may include, but are not limited to, the Internet, a cloud network, a Wireless Fidelity (Wi-Fi) network, a Personal Area Network (PAN), a Local Area Network (LAN), or a Metropolitan Area Network (MAN), a mobile wireless network, such as a Long-Term Evolution (LTE) network (for example, 4th Generation or 5th Generation (5G) mobile network (i.e., 5G New Radio)). Various devices of the network environment 100 may be configured to connect to the communication network 112, in accordance with various wired or wireless communication protocols. Examples of such wired and wireless communication protocols may include, but are not limited to, at least one of a Transmission Control Protocol and Internet Protocol (TCP/IP), User Datagram Protocol (UDP), Hypertext Transfer Protocol (HTTP), File Transfer Protocol (FTP), Zig Bee, EDGE, IEEE 802.11, light fidelity (Li-Fi), 802.16, IEEE 802.11s, IEEE 802.11g, multi-hop communication, wireless access point (AP), device to device communication, cellular communication protocols, Bluetooth (BT) communication protocols, or a combination thereof.

In operation, the customer device 104 may display a user-interface onto a display screen of the customer device 104. The user-interface may be accessed through a web client or may be a part of a software application pre-installed on the customer device 104. Through the displayed user-interface, the customer device 104 may receive a user input related to a purchase of a set of items from the retail store 116 using an in-store pickup option. The user input may be provided by the customer 120. Based on the received user input, a customer order may be generated and transmitted to the system 102. In this case, the customer order may be generated by the web client or the software application on the customer device 104. Additionally, or alternatively, the user input may be transmitted to the retail store management system 106, which may store the user input and generate the customer order. After the customer order is generated, the customer device 104 may be updated to display a message which may indicate that the customer order is placed. Also, the retail store management system 106 may transmit the customer order and/or details of the customer order to the system 102. The customer order may indicate a set of items purchased by the customer 120.

It should be noted that the process of placing a customer order through the customer device 104 may include several steps (such as item selection or payment) that are not mentioned in the foregoing description. A description of such steps is omitted from the disclosure for the sake of brevity.

The system 102 may be configured to receive the customer order from the customer device 104 (or the retail store management system 106) for an in-store pickup of the set of items at the retail store 116. The system 102 may be further configured to receive a pickup timeslot in which the received customer order associated with the retail store 116 may be scheduled for pickup by the customer 120 from the retail store 116. In an embodiment, the user input provided by the customer 120 for the purchase of the set of items from the retail store 116 may include the pickup timeslot. The pickup timeslot may be selected from a set of timeslots available for pickup of the customer order from the retail store 116. In an embodiment, the system 102 may recommend an earliest available timeslot and an optimal timeslot of the set of available timeslots on the customer device 104. The optimal timeslot may be such that a pickup wait time for the customer 120 within the timeslot may be within a threshold (for example, 2-3 minutes). The optimal timeslot may maximize a utilization (above a utilization threshold) of the group of human workers 122 of the retail store 116 within a specific period.

The system 102 may be further configured to receive a set of inputs from the retail store management system 106. The received set of inputs may include, for example, order servicing constraints and inventory information. The order servicing constraints may be related to the group of human workers 122 at the retail store 116. For example, the order servicing constraints may include a number of human workers who are available to work in timeslots within a first period, a number of hours each human worker works in a day, and the like. The inventory information may be related to items sold by the retail store 116. For example, the inventory information may include information related to an identity and a quantity of different items available in each of the set of departments 118 and/or a warehouse associated with the retail store 116.

The system 102 may be configured to divide the customer order into a set of suborders. In an embodiment, the customer order may be divided into the set of suborders based on the received inventory information. After the division of the customer order into the set of suborders, the system 102 may determine one or more timeslots in which the set of suborders may be serviced. The determination of the one or more timeslots may be based on the received pickup timeslot and the received order servicing constraints. The system 102 may identify, from the group of human workers 122, a set of human workers who may be available to work at the retail store 116 in the determined one or more timeslots. In an embodiment, the set of human workers may be identified based on the received order servicing constraints.

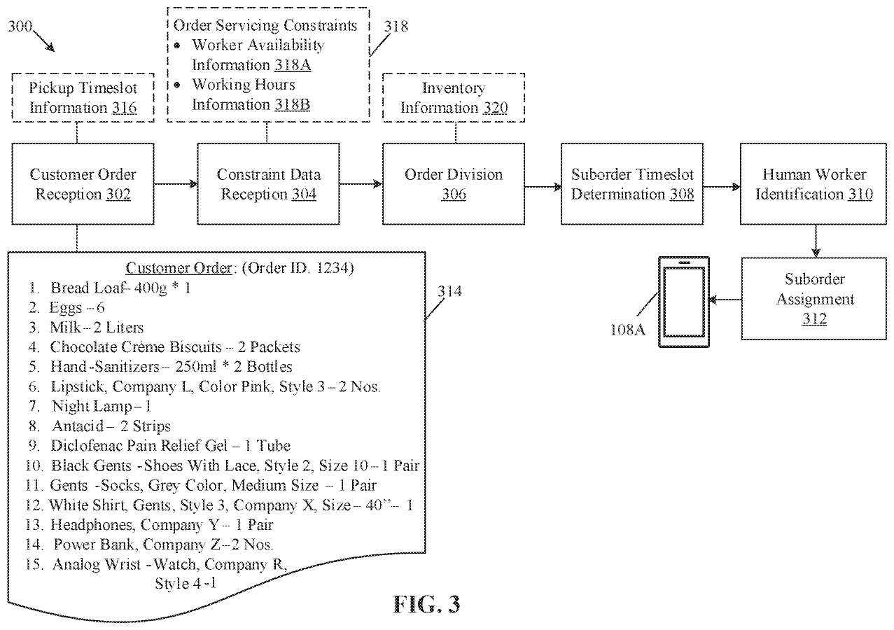

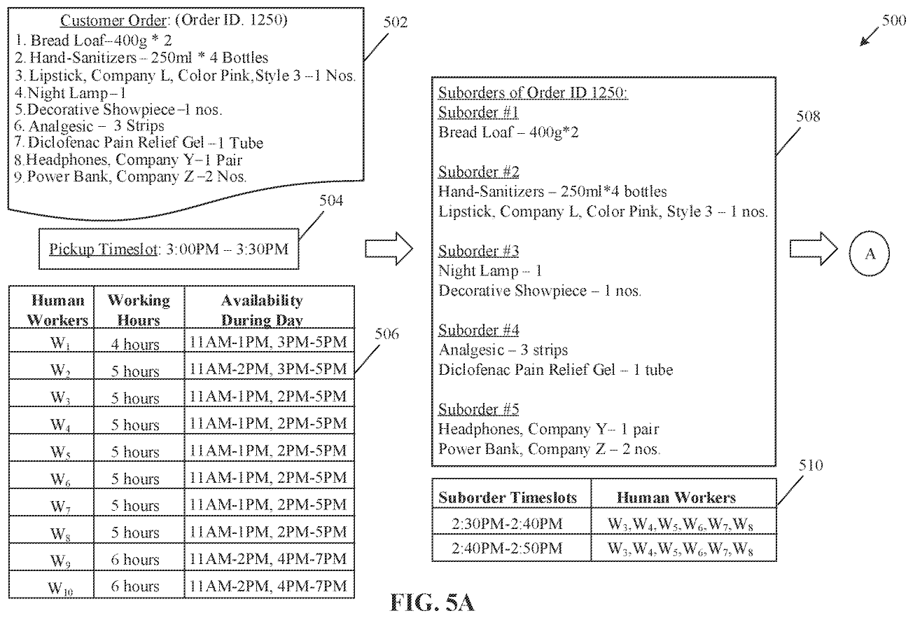

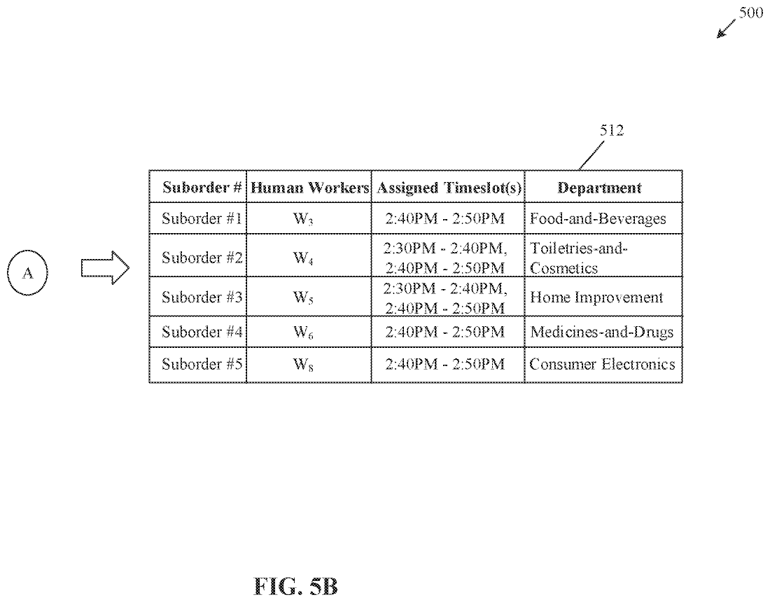

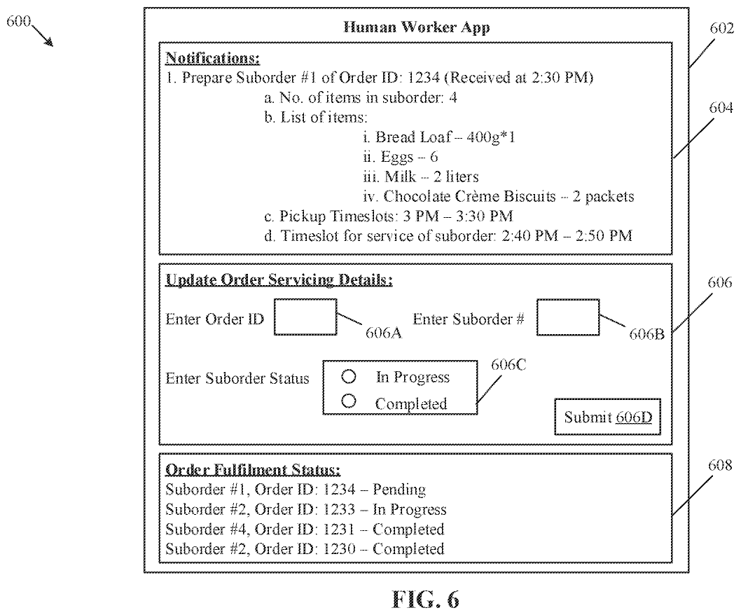

The system 102 may be further configured to solve an optimization problem to determine an assignment to service the set of suborders. The assignment may map the set of suborders to the identified set of human workers. The assignment may be determined such that a utilization of total hours available with the set of human workers to service the set of suborders may be above a threshold. The fulfillment of orders scheduled for in-store pickup is described further, for example, in FIGS. 3, 4, 7, 8, and 9. An example of the user-interface of a worker device for the fulfillment of orders scheduled for in-store pickup is provided, for example, in FIG. 6. An example of the fulfillment of orders scheduled for in-store pickup is provided, for example, in FIGS. 5A-5B. Various operations of the system 102 for the fulfillment of orders scheduled for in-store pickup are described further, for example, in FIGS. 3, 4, 7, and 8.

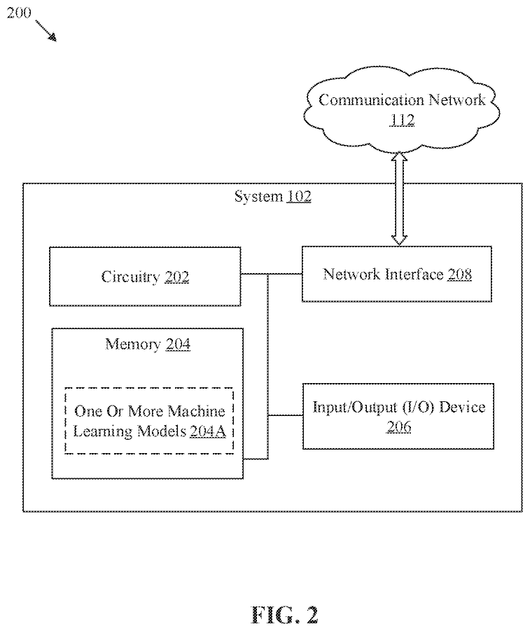

FIG. 2 is a block diagram that illustrates an exemplary system for fulfillment of orders scheduled for in-store pickup, in accordance with an embodiment of the disclosure. FIG. 2 is explained in conjunction with elements from FIG. 1. With reference to FIG. 2, there is shown the system 102. The system 102 may include circuitry 202, a memory 204, an input/output (I/O) device 206, and a network interface 208. The memory 204 may store one or more machine learning models 204A. The circuitry 202 may be communicatively coupled to the memory 204, the I/O device 206, and the network interface 208. The circuitry 202 may be configured to communicate with the customer device 104, the retail store management system 106, the group of worker devices 108, and/or the store manager device 110, by use of the network interface 208.

The circuitry 202 may include suitable logic, circuitry, and interfaces that may be configured to execute program instructions associated with different operations to be executed by the system 102. The circuitry 202 may be implemented based on a number of processor technologies known in the art. Examples of the processor technologies may include, but are not limited to, a Central Processing Unit (CPU), an x86-based processor, a Reduced Instruction Set Computing (RISC) processor, an Application-Specific Integrated Circuit (ASIC) processor, a Complex Instruction Set Computing (CISC) processor, a Graphical Processing Unit (GPU), a co-processor, or a combination thereof.

The memory 204 may include suitable logic, circuitry, and/or interfaces that may be configured to store a set of instructions executable by the circuitry 202. The memory 204 may be configured to store operating systems and associated applications. In accordance with an embodiment, the memory 204 may be also configured to store the one or more machine learning models 204A. In addition, the memory 204 may also store the customer order and the user input including the pickup timeslot associated with the customer order that may be received from the customer device 104. Further, the memory 204 may store the set of inputs that may be received from the database 114, via the retail store management system 106. Examples of implementation of the memory 204 may include, but are not limited to, Random Access Memory (RAM), Read Only Memory (ROM), Electrically Erasable Programmable Read-Only Memory (EEPROM), Hard Disk Drive (HDD), a Solid-State Drive (SSD), a CPU cache, and/or a Secure Digital (SD) card.

Each of the one or more machine learning models 204A may be a model which may be trained to identify a relationship between inputs, such as features in a training dataset of a history of customer orders and output labels, such as an estimated servicing time of a suborder of a customer order. Each machine learning model may be defined by its hyper-parameters, for example, number of weights, cost function, input size, number of layers, and the like. The hyper-parameters of each machine learning model may be tuned before or after the training of the respective machine learning models. In training, an input feature from a training dataset may be fed to a machine learning model and weights of the model may be updated based on a supervised learning algorithm. The weights may be iteratively updated until the loss associated with the model is below a threshold. After several epochs of the training on the features in the training dataset, each machine learning model may be trained to output a result for a set of inputs. The result may include an estimated servicing time of a suborder of a customer order based on the set of inputs. Examples of the one or more machine learning models 204A may include, but is not limited to, a Support Vector Machine (SVM) model and a deep learning (DL) model (e.g., a deep neural network (DNN)).

The one or more machine learning models 204A may include electronic data, which may be implemented as, for example, a software component of an application executable on the system 102. The one or more machine learning models 204A may rely on libraries, external scripts, or other logic/instructions for execution by a processing device, such as, the circuitry 202. The one or more machine learning models 204A may include code and routines configured to enable a computing device, such as, the circuitry 202, to perform one or more operations for estimation of a servicing time of a suborder of a customer order. Additionally, or alternatively, the one or more machine learning models 204A may be implemented using hardware including a processor, a co-processor, a microprocessor (e.g., to perform or control performance of one or more operations), a field-programmable gate array (FPGA), or an application-specific integrated circuit (ASIC). Alternatively, in some embodiments, the one or more machine learning models 204A may be implemented using a combination of hardware and software.

The I/O device 206 may include suitable logic, circuitry, interfaces, and/or code that may be configured to receive an input from a user. The I/O device 206 may be further configured to provide an output to the user. The I/O device 206 may include various input and output devices, which may be configured to communicate with the circuitry 202. Examples of the input devices may include, but are not limited to, a touch screen, a keyboard, a mouse, a joystick, and/or a microphone. Examples of the output devices may include, but are not limited to, a display screen and/or a speaker.

The network interface 208 may include suitable logic, circuitry, code, and/or interfaces that may be configured to facilitate communication between the circuitry 202, the customer device 104, the retail store management system 106, the group of worker devices 108, and/or the store manager device 110, via the communication network 112, The network interface 208 may be implemented by use of various known technologies to support wired or wireless communication of the system 102 with the communication network 112, The network interface 208 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, or a local buffer circuitry.

The network interface 208 may be configured to communicate via wireless communication with networks, such as the Internet, an Intranet or a wireless network, such as a cellular telephone network, a wireless local area network (LAN), and a metropolitan area network (MAN). The wireless communication may be configured to use one or more of a plurality of communication standards, protocols and technologies, such as Global System for Mobile Communications (GSM), Enhanced Data GSM Environment (EDGE), wideband code division multiple access (W-CDMA), Long Term Evolution (LTE), code division multiple access (CDMA), a 5th generation network such as 5G new radio (NR) network, a 5G smart antenna, time division multiple access (TDMA), Bluetooth, Wireless Fidelity (Wi-Fi) (such as IEEE 802.11a, IEEE 802.11b, IEEE 802.11g or IEEE 802.11n), voice over Internet Protocol (VoIP), light fidelity (Li-Fi), Worldwide Interoperability for Microwave Access (Wi-MAX), a protocol for email, instant messaging, and a Short Message Service (SMS). Te network interface 208 may be capable to communicate with a 5G communication network and will include appropriate 5G support functionality such as, but not limited to, a 5G NR, a V2X Infrastructure, and a 5G Smart Antenna. Various operations of the circuitry 202 for the fulfillment of orders scheduled for in-store pickup are described further, for example, in FIGS. 3, 4, 7, and 8.

FIG. 3 is a diagram that illustrates an exemplary processing pipeline for fulfillment of orders scheduled for in-store pickup, in accordance with an embodiment of the disclosure. FIG. 3 is explained in conjunction with elements from FIG. 1 and FIG. 2. With reference to FIG. 3, there is shown a processing pipeline 300 of operations from 302 to 312 to depict slot selection and pickup scheduling. The operations 302 to 312 of the processing pipeline 300 may be executed by any computing system, such as by the system 102 of FIG. 1 or the circuitry 202 of FIG. 2.

At 302, a customer order may be received. In an embodiment, the circuitry 202 may be configured to receive the customer order associated with a customer (for example, the customer 120). The customer order may be indicative of a set of items that may be purchased by the customer 120 or may be added in a digital cart for purchase. As shown, for example, a customer order 314 may be placed by the customer 120 and received by the circuitry 202. The customer order 314 may be identified by an order ID such as “1234”. The set of items in the customer order 314 may include, for example, bread, eggs, milk, chocolate crème biscuits, hand-sanitizers, lipsticks, a night lamp, antacid strips, a tube of diclofenac pain relief gel, a pair of shoes, a pair of gents socks, a white colored gents shirt, a pair of headphones, a set of power banks, analog wristwatch, and the like. The customer order may be received from the customer device 104 for an in-store pickup of the set of items at the retail store 116.

The circuitry 202 may be further configured to receive a user input, which may be provided by the customer 120 through the customer device 104. The user input may be associated with the customer order and may include pickup timeslot information 316. For example, the pickup timeslot information 316 may include a pickup timeslot in which the customer order 314 associated with the retail store 116 may be scheduled for pickup from the retail store 116. The pickup timeslot may be selected by the customer 120 from a set of timeslots available for pickup of items of the customer order from the retail store 116. In an embodiment, the system 102 may recommend an earliest available timeslot and/or an optimal timeslot on the customer device 104. Both the earliest available timeslot and the optimal timeslot may be selected from the set of available timeslots. The optimal timeslot may be such that a pickup wait time for the customer 120 within the timeslot may be below a threshold. Also, the optimal timeslot may maximize the utilization of the group of human workers 122 to a value that may be above a utilization threshold.

The customer device 104 may transmit (directly or through the retail store management system 106) the generated customer order and the user input including the pickup timeslot information 316 to the system 102. The circuitry 202 may receive the customer order and the user input from the customer device 104 (or from the retail store management system 106). In an embodiment, the circuitry 202 may be configured to process customer orders from a set of customers on a first-come-first-serve basis. In another embodiment, the circuitry 202 may assign a priority to the customer orders based on one or more of a membership or loyalty points of a customer with the retail store 116, a number of items in the customer order, an invoiced amount of the customer order, a location-based rule for the customers (who placed the orders), or a payment mode associated with the customer order.

At 304, constraint data may be received. In an embodiment, the circuitry 202 may be configured to receive the constraint data from the retail store management system 106. The retail store management system 106 may retrieve the constraint data from the database 114 and may transmit the retrieved constraint data to the system 102. For example, the constraint data may include order servicing constraints 318, which may be related to the group of human workers 122 at the retail store 116. For example, the order servicing constraints 318 may include worker availability information 3182A and working hours information 318B.

The worker availability information 3182A may include information related to a number of human workers (of the group of human workers 122) who may be available to work in timeslots within a first period. The retail store 116 may employ a total of 25 human workers and the retail store 116 may operate between 11AM-7 PM on a certain day (e.g., Monday). On a given day, out of the total 25 human workers, 6 human workers may be available within timeslots between 11 AM-1 PM, 10 human workers may be available for timeslots between 2 PM-3 PM, and 15 human workers may be available for timeslots between 3 PM-5 PM. Further, 22 human workers may be available for timeslots between 5 PM-6 PM, and 8 human workers may be available for timeslots between 6 PM-7 PM. Herein, the first period may include one or more days or one or more weeks from the date the customer order is placed.

The working hours information 318B may include information related to a number of hours each human worker of the group of human workers 122 works on a certain day (e.g., Monday). For example, on a given day, out of the 25 human workers at the retail store 116, a first set of 3 human workers may work for 6 hours each, a second set of 5 human workers may work for 5 hours each, a third set of 10 human workers may work for 8 hours each, and a fourth set of 7 human workers may work for 7 hours each. Thus, a total of 25 human workers may work for a total of 172 hours on the given day. As another example, 3 human workers may be assigned to work in each of the set of departments 118 and in various timeslots between 11 AM to 7 PM. Each human worker of the group of human workers 122 may work for a total of 6 hours to service customer orders. The number of hours a human worker may be assigned to a department in a day may be used to assign tasks associated with servicing of the customer orders or sub-orders related to the department. Also, the number of human workers available in each timeslot and the number of hours that each human worker may work in the day may be used to assign tasks associated with servicing of the customer orders to each human worker. In some scenarios, there may be variations in the number of customer orders and the availability of the human workers on a given day or within a given period. For example, even though the working hours for each human worker may be predetermined (e.g., 6 hours), the availability of the human workers may vary as one or more human workers may be unavailable due to personal work or health reasons for a certain duration in the day.

At 306, the customer order may be divided. In an embodiment, the circuitry 202 may be configured to divide the customer order 314 into a set of suborders. In an embodiment, the customer order 314 may be divided into the set of suborders based on inventory information. In an embodiment, the circuitry 202 may be configured to receive the inventory information from the retail store management system 106. The retail store management system 106 may retrieve the inventory information from the database 114 and may transmit the retrieved inventory information to the system 102. For example, inventory information 320 is shown. The inventory information 320 may be related to the items sold by the retail store 116 and may include information related to an identity and a quantity of different items available in the each of the set of departments 118 and/or a warehouse associated with the retail store 116. In an embodiment, the inventory information 320 may include a database of the items sold by the retail store 116. For each of the items, the database of the items may include a unique product code (UPC) or an identifier, at least one of an item weight or an item volume, an item quantity, and a department to which the respective time may belong. For example, the UPC code of an item may be a 12-digit identification code of the item. The weight or volume of a unit quantity of the item may be, for example, 2 lbs, 16oz, or 750 ml. The quantity of the item may be, for example, a pack of 6 units. The department of the item may be, for example, the food-and-beverages department 118A. In the food-and-beverages department 118A, the sub-department of the item may be dairy products (e.g., dairy products aisle).

The inventory information 320 may be used to identify a first set of items of the customer order 314 and to check if such items are available in the inventory. Also, the inventory information 320 may be used to determine if a second set of items of the customer order 314 is out of stock. Based on the UPC of each item in the inventory information 320, the circuitry 202 may identify each item in the customer order 314 and determine information indicative of the department or sub-department of each item in the customer order 314. Based on the department or sub-department of each item in the customer order 314, the set of items in the customer order 314 may be divided into the set of suborders.

By way of example, and not limitation, the customer order 314 may be divided into six suborders based on the set of items in the customer order 314 and individual departments (in the set of departments 118) to which the set of items may belong. The six suborders of the customer order 314 may include a first suborder associated with the food-and-beverages department 118A, a second suborder associated with the toiletries-and-cosmetics department 118B, a third suborder associated with the home improvement department 118C, a fourth suborder associated with the medicines-and-drugs department 118D, a fifth suborder associated with the shoes-and-apparels department 118E, and a sixth suborder associated with the consumer electronics department 118N. As shown, for example, the first suborder may include a bread loaf, eggs, milk, and chocolate crème biscuits, and the second suborder may include hand-sanitizers and lipsticks. Further, the third suborder may include night lamp and the fourth suborder may include antacid strips and a tube of diclofenac pain relief gel. The fifth suborder may include a pair of gent's shoes, a pair of gent's socks, and a white colored gent's shirt. The sixth suborder may include a pair of headphones, a set of power banks, and an analog wristwatch.

In an embodiment, the customer order 314 may be divided into the set of suborders based on other factors, such as, but not limited to, a number of items of the customer order 314 related to each department or sub-department and a location of each department or sub-department associated with each item in the customer order 314. For example, if the number of items of the customer order 314 related to a department or sub-department is less than a threshold, then such items may be added to another suborder. For instance, items related to the home improvement department 118C (e.g., the night lamp) may be added to the sixth suborder associated with the consumer electronics department 118N if the number of items related to the home improvement department 118C may be less than 2 (i.e., a threshold). In another example, the items related to the consumer electronics department 118N (e.g., the night lamp) may be added to the fourth suborder associated with the medicines-and-drugs department 118D if the consumer electronics department 118N is close to the medicines-and-drugs department 118D than other departments and no worker is available to service the suborder of the consumer electronics department 118N.

At 308, one or more timeslots for the set of suborders may be determined. In an embodiment, the circuitry 202 may be configured to determine one or more timeslots in which the set of suborders may be serviced. The one or more timeslots may be determined based on the received pickup timeslot and the received order servicing constraints 318. For example, the received pickup timeslot associated with the customer order 314 may be 3:00 PM-3:30 PM. Further, based on the order servicing constraints 318, such as, the worker availability information 3182A, the circuitry 202 may determine that 10 human workers may be available for timeslots between 2 PM-3 PM. In an embodiment, the circuitry 202 may estimate a servicing time duration of each suborder of the set of suborders. As an example, the servicing time duration may be a median time duration that may be estimated based on a size of a respective suborder of the set of suborders. The sizes of the set of suborders may be “4”, “2”, “1”, “2”, “3”, and “3”, respectively, for the first suborder, second suborder, third suborder, fourth suborder, fifth suborder, and the sixth suborder. Consider that the median time durations for a suborder of size “4” may be 8 minutes, a suborder of size “3” may be 6 minutes, a suborder of size “2” may be 3 minutes, and a suborder of size “1” may be 2 minutes. In such a case, the circuitry 202 may determine 2:40 PM-2:50 PM as a timeslot for each of the six suborders of the customer order 314. 10 minutes duration may be enough time to service suborders which have a size between 1 to 4 items. The completion of each of the six suborders within the determined one or more timeslots (i.e., 2:40 PM-2:50 PM) may ensure that the customer order 314 may be serviced before the pickup timeslot (i.e., 3:00 PM-3:30 PM).

At 310, a set of human workers may be identified from the group of human workers 122. In an embodiment, the circuitry 202 may be configured to identify, from the group of human workers 122, a set of human workers who may be available to work at the retail store 116 in the determined one or more timeslots. In an embodiment, the set of human workers available in the determined one or more timeslots may be determined based on the order servicing constraints 318. For example, based on the worker availability information 3182A, the circuitry 202 may identify that a set of 10 human workers may be available to work in timeslots between 2 PM-3 PM.

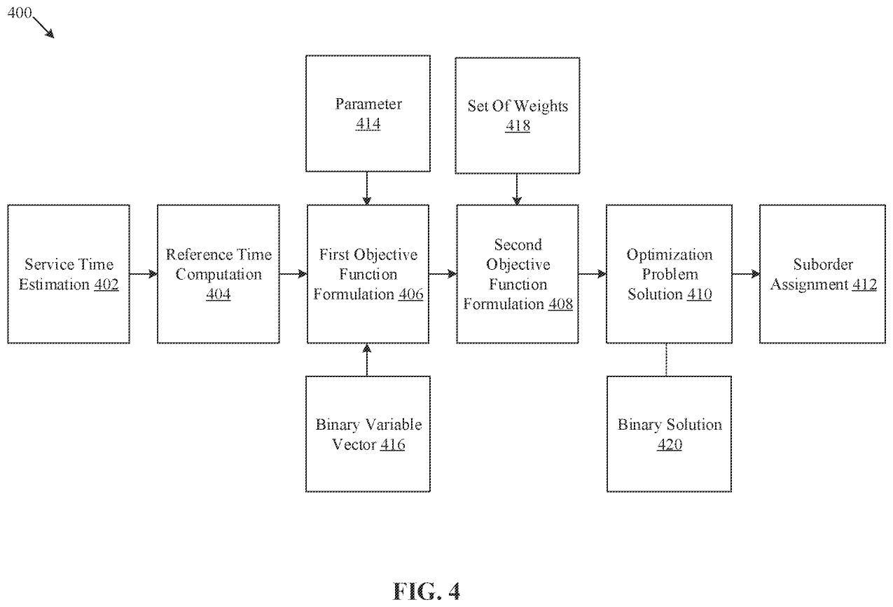

At 312, the set of suborders may be assigned to the identified set of human workers. In an embodiment, the circuitry 202 may be configured to assign the set of suborders to the identified set of human workers. In an embodiment, the circuitry 202 may be configured to solve an optimization problem to determine an assignment to service the set of suborders. The assignment may map the set of suborders to the identified set of human workers. The assignment may be determined such that the utilization of total hours available with the set of human workers to service the set of suborders may be above a threshold (for example, 90% or above). The optimization problem and the solution of the optimization problem are described further, for example, in FIG. 4.

The circuitry 202 may be further configured to transmit a first notification to a first electronic device (e.g., the first worker device 1082A, as shown in FIG. 3) associated with a first human worker (e.g., first human worker 122A) of the identified set of human workers. In an embodiment, the first notification may be transmitted to the first worker device 1082A via the retail store management system 106 or the store manager device 110. The circuitry 202 may control the first electronic device (e.g., the first worker device 1082A) associated with the first human worker 122A to display the transmitted first notification based on the assignment. The first notification may include a first suborder of the set of suborders mapped to the first human worker 122A and details associated with the first suborder. An example of a user interface associated with the first worker device 1082A that may display the first notification is provided, for example, in FIG. 6.

FIG. 4 is a diagram that illustrates an exemplary processing pipeline for determination of an assignment to service a set of suborders of a customer order, in accordance with an embodiment of the disclosure. FIG. 4 is explained in conjunction with elements from FIG. 1, FIG. 2, and FIG. 3. With reference to FIG. 4, there is shown a processing pipeline 400 of operations from 402 to 412. The operations from 402 to 412 may be executed by any computing system such as by the system 102 of FIG. 1 or the circuitry 202 of FIG. 2.

At 402, a servicing time may be estimated. In an embodiment, the circuitry 202 may be configured to estimate a servicing time duration for each suborder of the set of suborders of the customer order. In an embodiment, for each suborder of the set of suborders, the servicing time duration may be a median time duration that may be estimated based on a size of a respective suborder of the set of suborders. For example, the set of suborders of the customer order 314 may include six suborders of sizes “4”, “2”, “1”, “2”, “3”, and “3”, respectively, for the first suborder, the second suborder, the third suborder, the fourth suborder, the fifth suborder, and the sixth suborder. The median time durations for a suborder of size “4” may be 8 minutes, a suborder of size “3” may be 6 minutes, a suborder of size “2” may be 3 minutes, and a suborder of size “1” may be 2 minutes. Thus, the servicing time durations for the six suborders of the customer order 314 may be 8 minutes, 3 minutes, 2 minutes, 3 minutes, 6 minutes, and 6 minutes, respectively, for the first suborder, the second suborder, the third suborder, the fourth suborder, the fifth suborder, and the sixth suborder.

The median time to service an average customer order or suborder may be a useful statistic to assign tasks to the group of human workers 122 as a median value in a dataset may be robust to outliers. For example, the median time to fulfill the average customer order (e.g., of 10 items) may be 20 minutes. In an embodiment, based on the size of suborders or orders, multiple median time values may be used to estimate servicing time duration. For example, a first median time associated with servicing of a small order (e.g., an order of a size less than a threshold, such as 5 items) and a second median time associated with servicing of a large order (e.g., an order of a size greater than the threshold) may be used for the estimation of the servicing time duration. As an example, the first median time may be 12 minutes and the second median time may be 25 minutes.

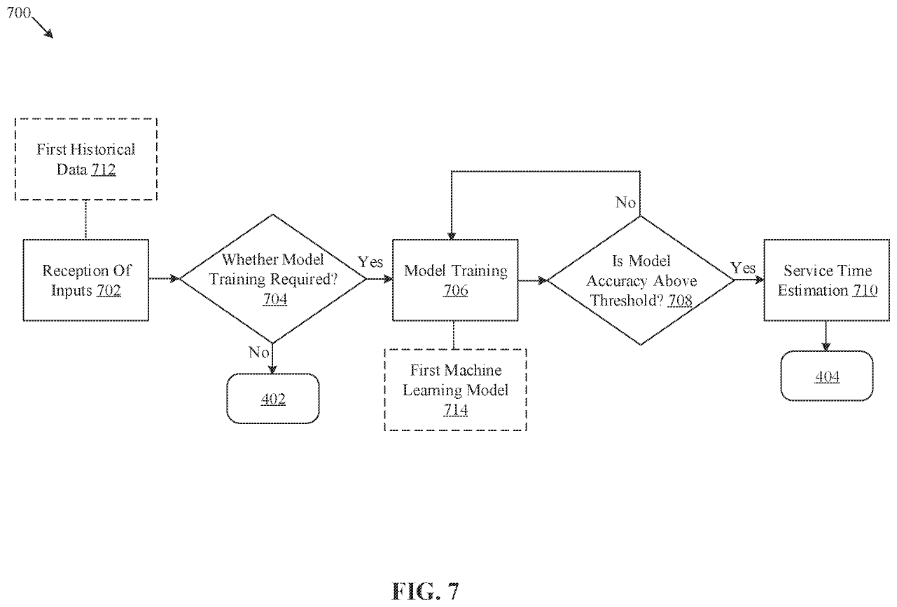

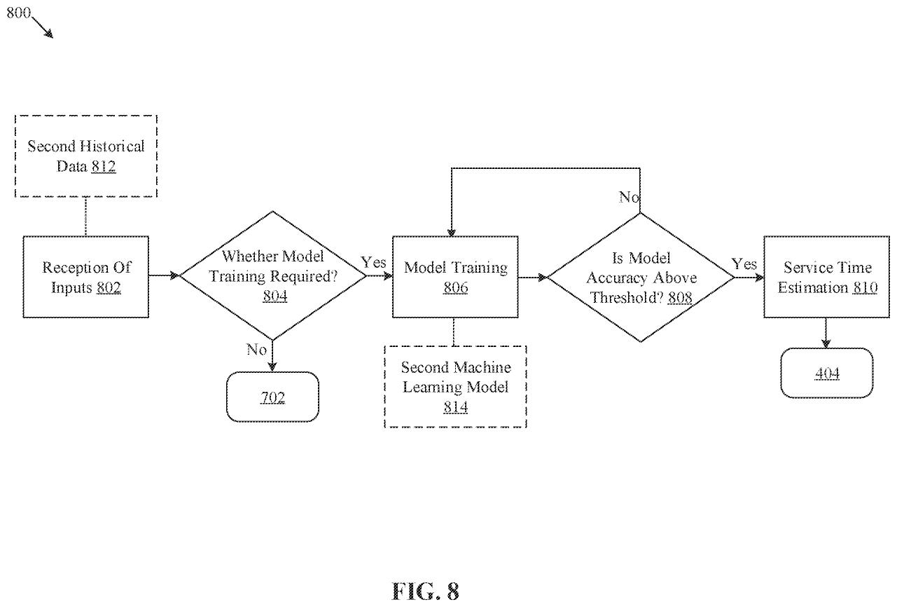

In an embodiment, the servicing time duration for each suborder may be estimated by use of a trained machine learning model (e.g., the one or more machine learning models 204A). The training and use of a first machine learning model are described, for example, in FIG. 7. The training and use of a second machine learning model are described further, for example, in FIG. 8.

At 404, a reference time may be computed. In an embodiment, the circuitry 202 may be configured to compute a reference time duration based on the estimated servicing time duration for each suborder of the set of suborders and a number of suborders included in the set of suborders. The reference time duration may be a target assignment time for each human worker to service the different suborders of the customer order 314. By way of example, and not limitation, the reference time duration may be computed using equation (1), which is given as follows:

$$\overline{µ} = \frac{{\sum }_{i} {t}_{i}}{\vert O \vert} \qquad ( 1 )$$

where, tᵢ may represent a median time for completion of a suborder Oᵢ of an order O; |O| may represent a number of suborders of the order O; and ∥̅ may represent the reference time duration.

At 406, a first objective function may be formulated. In an embodiment, the circuitry 202 may be configured to select parameters 414 for the first objective function of an optimization problem based on the computed reference time duration and the estimated servicing time duration. For example, the circuitry 202 may select the computed reference time (i.e., ˜̅) and the estimated servicing time duration (e.g., the median time, tᵢ) for each suborder (e.g., suborder Oᵢ) of the customer order 314 (e.g., order O) as the parameters 414 for the first objective function. The circuitry 202 may be configured to further select a vector of binary variables (e.g., the binary variable vector 416) for each human worker of the identified set of human workers. For a first human worker (e.g., the first human worker 122A) of the identified set of human workers, each binary variable in the vector of binary variables (e.g., the binary variable vector 416) may represent whether or not a respective suborder of the set of suborders is to be assigned or mapped to the first human worker 122A. By way of example, and not limitation, the binary variable vector 416 may be represented by (2), as follows:

$${y}_{ij} = \{ \begin{matrix}1 , & if suborder {O}_{i} is assigned to human worker {W}_{j} , and \\ 0 , & otherwise\end{matrix} \qquad ( 2 )$$

where the collection of y_{ij's} for all i and j may represent the binary variable vector 416.

The circuitry 202 may be configured to formulate the first objective function based on the selected parameters 414 and the selected binary variable vector 416. The formulated first objective function (e.g., F_{D}) may be represented by equation (3) as follows:

$${F}_{D} = {\sum }_{{W}_{j} ∈ W} \vert {\sum }_{{O}_{i} ∈ O} ( {t}_{i} {y}_{ij} - \overline{µ} ) \vert \qquad ( 3 )$$

At 408, a second objective function may be formulated. In an embodiment, the circuitry 202 may be configured to formulate the second objective function of the optimization problem based on a set of weights 418. In an embodiment, the circuitry 202 may be configured to determine the set of weights 418 for each human worker of the identified set of human workers, based on the estimated servicing time duration for each suborder of the set of suborders. For a first human worker (e.g., the first human worker 122A) of the identified set of human workers, each weight of the determined set of weights 418 may represent an extent by which a corresponding suborder of the set of suborders is mappable or assignable to the first human worker 122A. For example, consider that uᵢⱼ may represent a weight (or utility) for a suborder Oᵢ of an order O with a human worker Wⱼ. Higher the weight for a suborder with a human worker, more beneficial or suitable it may be to assign the particular suborder to that human worker. In an embodiment, the circuitry 202 may determine a weight (e.g., uᵢⱼ) for a suborder (or order) Oᵢ with a human worker Wⱼ as a reciprocal of the servicing time duration (uᵢⱼ=1/tᵢⱼ). tᵢⱼ may represent the estimated servicing time duration for the suborder (or order) Oᵢ by the human worker Wⱼ.

In an embodiment, the circuitry 202 may formulate the second objective function of the optimization problem based on the selected vector of binary variables (i.e., the binary variable vector 416) and the determined set of weights 418. By way of example, and not limitation, the formulated second objective function (e.g., F_{M}) may be represented by equation (4) as follows:

$${F}_{M} = {\sum }_{{W}_{j} ∈ W} {\sum }_{{O}_{i} ∈ O} {u}_{ij} {y}_{ij} \qquad ( 4 )$$

At 410, the optimization problem may be solved. In an embodiment, the circuitry 202 may be configured to solve the formulated first objective function and the formulated second objective function. To solve the optimization problem, the circuitry 202 may minimize the first objective function (i.e., F_{D}, represented by the equation (3)) and maximize the second objective function (i.e., F_{M}, represented by the equation (4)). The minimization of the first objective function (i.e., F_{D}) may correspond to a fair division approach to divide the set of suborders of an order fairly amongst the identified set of human workers available in the required timeslots. The objective of the fair division algorithm may be to minimize a total absolute deviation from the computed reference time duration (i.e., the target assignment, μ̅) for all human workers in the identified set of human workers. The maximization of the second objective function (i.e., F_{M}) may correspond to an approach to match the divided suborders to the identified set of human workers. Together, the approach to minimize the first objective function and maximize the second objective function may be referred to as a fair division and matching approach for assignment for individual suborders to the identified set of human workers available within a required timeslot(s). The formulated first objective function (i.e., F_{D}) and the formulated second objective function (i.e., F_{M}) may be solved to generate a binary solution (e.g., a binary solution 420) of the optimization problem. The generated binary solution 420 may include a vector of binary values of the selected vector of binary variables (i.e., the binary variable vector 416). An assignment of the generated binary solution 420 is provided at 412.

In some scenarios, a human worker W₁ with an experience of several years, may work in the food-and-beverages department 118A (e.g., a meat sub-department) of the retail store 116. The human worker Wi may be able to service suborders associated with the food-and-beverages department 118A (e.g., the meat sub-department) more efficiently than a human worker W₂ who may have recently joined the retail store 116. For a certain suborder O₅, the estimated servicing time duration for the human worker W₁ may be t_{5,1}=10 minutes and the estimated servicing time duration for the human worker W₂ as t_{5,2}=20 minutes. The weight for the human worker W₁ may be given by u_{5,1}=0.10 and the weight for the human worker W₂ may be given by u_{5,2}=0.05. In such scenarios, the matching approach may be used to maximize an overall matching score for the suborder O₅ and to assign the suborder O₅ to the human worker W₁ (other human workers are ignored for this example). In certain instances, the use of only the matching approach for the determination of the assignment may lead to an assignment of most (or all) suborders associated with the food-and-beverages department 118A (e.g., the meat sub-department) to the human worker W₁, instead of the human worker W₂. Based on the use of the fair division approach, both the human workers W₁ and W₂ may be assigned approximately the same amount of work or tasks in terms of total completion times associated with suborders serviced by each of the human workers W₁ and W₂. For example, the human worker W₁ may be assigned two suborders that may be serviced in a total time of 10+10=20 minutes. Similarly, the human worker W₂ may be assigned a third suborder to be serviced in the same 20 minutes time duration. Thus, the three suborders may be fairly divided and matched amongst the two human workers Wi and W₂.

At 412, the set of suborders may be assigned. In an embodiment, the circuitry 202 may be configured to determine an assignment to service the set of suborders. The assignment to service the set of suborders may be determined based on the binary solution 420. Herein the assignment may map the set of suborders to the identified set of human workers. For example, consider that the identified set of human workers includes 10 human workers who may be available to service the set of suborders (e.g., six suborders) of the customer order 314. The generated binary solution 420 may be represented by a vector of binary values. An assignment of the generated binary solution 420 is illustrated in Table 1, as follows:

TABLE 1
An assignment of the generated binary solution 420

| | |
|---|---|
| Human | Sub-orders |

| workers | O₁ | O₂ | O₃ | O₄ | O₅ | O₆ |
|---|---|---|---|---|---|---|
| W₁ | 0 | 0 | 0 | 0 | 0 | 0 |
| W₂ | 0 | 1 | 1 | 0 | 0 | 0 |
| W₃ | 1 | 0 | 0 | 0 | 0 | 0 |
| W₄ | 0 | 0 | 0 | 0 | 0 | 0 |
| W₅ | 0 | 0 | 0 | 0 | 0 | 0 |
| W₆ | 0 | 0 | 0 | 1 | 0 | 0 |
| W₇ | 0 | 0 | 0 | 0 | 0 | 0 |
| W₈ | 0 | 0 | 0 | 0 | 0 | 1 |
| W₉ | 0 | 0 | 0 | 0 | 0 | 0 |
| W₁₀ | 0 | 0 | 0 | 0 | 1 | 0 |

The assignment of the set of six suborders (e.g., O₁ to O₆) to the identified set of 10 human workers (e.g., W₁ to W₁₀) may be determined based on the generated binary solution 420. In the binary solution 420, if a value of 1 is associated with a human worker for a particular suborder, then that human worker may be assigned to service the particular suborder. If a value “0” is associated with a human worker for a particular suborder in the generated binary solution 420, then that human worker may not be assigned to service the particular suborder. With reference to Table 1, it may be determined that the suborder O₁ may be assigned to the human worker W₃ and the suborders O₂ and O₃ may be assigned to the human worker W₂. In addition, the suborder O₄ may be assigned to the human worker W₆, the suborder O₅ may be assigned to the human worker W₁₀, and the suborder O₆ may be assigned to the human worker W₈. Based on the binary solution 420, the circuitry 202 may determine that the human workers W₁, W₄, W₇, and W₉ may not be assigned to any of the six suborders (i.e., O₁ to O₆). It should be noted that data provided in Table 1 may merely be taken as experimental data and may not be construed as limiting the present disclosure. An example of the determination of the assignment for a set of suborders of an order is provided in FIGS. 5A-5B.

In an embodiment, the determination of the assignment may be such that the utilization of total hours available with the set of human workers to service the set of suborders is above a threshold. In some instances, the determination of the assignment may be based on the matching approach. The matching approach (i.e., the maximization of the second objective function, F_{M}) may be used to maximize the utilization of total hours available with the identified set of human workers to service the set of suborders of the customer order 314. In some other instances, the matching approach may be used for multiple customer orders received in a certain time period (e.g., a day, a week, or a month) so that the utilization of total hours available with the set of human workers to service suborders (of the multiple customer orders) is above the threshold (e.g., a 95% utilization).

The determination of the assignment may be further based on the use of the fair division approach (i.e., the minimization of the first objective function, F_{D}). The fair division approach may be used to minimize the total absolute deviation from the computed reference time duration (i.e., the target assignment, μ̅) for all human workers of the identified set of human workers. Based on the minimization of the first objective function, a service level for the customer order may be maximized to a value which may be above a service level threshold (e.g., 90%). The customer 120 may not have to wait for an extended period of time when the customer 120 arrives to pick up the customer order 314 in the timeslot (specified in the pickup timeslot information 316). This may enhance the shopping experience of the customer 120 with the retail store 116.

FIGS. 5A and 5B are diagrams that collectively illustrate an example scenario of an assignment of a set of suborders of an order to a set of human workers of a retail store, in accordance with an embodiment of the disclosure. FIGS. 5A and 5B are explained in conjunction with elements from FIG. 1, FIG. 2, FIG. 3, and FIG. 4. With reference to FIGS. 5A and 5B, there is shown a diagram 500 which includes a customer order 502, pickup timeslot information 504, constraint data 506, a set of suborders 508, suborder timeslot data 510, and assignment information 512.

At any time-instant, the circuitry 202 may be configured to receive the customer order 502 via the retail store management system 106 or via the customer device 104. The customer order 502 may be indicative of a set of items that may be purchased by the customer 120 or may be added in a digital cart for purchase. The customer order 502 may be identified by an order ID such as “1250”. The set of items in the customer order 502 may include, for example, bread loafs, hand-sanitizers, a lipstick, a night lamp, a decorative showpiece, analgesic strips, a tube of diclofenac pain relief gel, a pair of headphones, a set of power banks, and the like. The customer order 502 may be for an in-store pickup of the set of items at the retail store 116. The circuitry 202 may be configured to receive a user input through the customer device 104. The user input may be associated with the customer order 502 and may include the pickup timeslot information 504. For example, the pickup timeslot information 504 may include a pickup timeslot (e.g., 3:00 PM to 3:30 PM, as shown in FIGS. 5A-5B) in which the customer order 502 associated with the retail store 116 may be scheduled for pickup from the retail store 116.

The circuitry 202 may be configured to receive the constraint data 506 from the retail store management system 106. In some instances, the retail store management system 106 may retrieve the constraint data 506 from the database 114 and may transmit the retrieved constraint data to the system 102. For example, the constraint data 506 may include order servicing constraints 318 which may be related to the group of human workers 122 at the retail store 116. The order servicing constraints 318 may include, for example, the worker availability information 3182A and the working hours information 318B. As shown, for example, the constraint data 506 may include working hours of the group of human workers 122 (e.g., human workers W₁ to W₁₀) at the retail store 116. While the human workers W₂, W₃, W₄, W₅, W₆, W₇, and W₈ may each work for 5 hours on given day to service orders, the human worker W₁ may work for 4 hours on the same day and the human workers W₉ and W₁₀ may each work for 6 hours on the same day.

The circuitry 202 may be configured to divide the customer order 502 into a set of suborders 508. The division of the customer order 502 into the set of suborders 508 may be based on the inventory information 320. For example, the customer order 502 may be divided into the set of suborders 508 which may include five suborders, such as suborder 1, suborder 2, suborder 3, suborder 4, and suborder 5. The suborder 1 may include the bread loafs and may be associated with the food-and-beverages department 1182A. The suborder 2 may include the hand-sanitizers and the lipstick and may be associated with the toiletries-and-cosmetics department 118B. The suborder 3 may include the night lamp and the decorative showpiece and may be associated with the home improvement department 118C. Further, the suborder 4 may include the analgesic strips and the diclofenac pain relief gel and may be associated with the medicines-and-drugs department 118D. In addition, the suborder 5 may include the pair of headphones and the set of power banks and may be associated with the consumer electronics department 118N.

Based on the pickup timeslot information 504 and the constraints data 506, the circuitry 202 may determine one or more timeslots in which the set of suborders 508 may be serviced. From the group of human workers 122, the circuitry 202 may identify a set of human workers who may be available to work at the retail store 116 in the determined one or more timeslots. The determination of the one or more timeslots and the identification of the set of human workers are described further, for example, in FIG. 3.

In an embodiment, the circuitry 202 may determine suborder timeslot data 510 based on the determined one or more timeslots and the identified set of human workers. The suborder timeslot data 510 may include the determined one or more timeslots to service the set of suborders 508 and the identified set of human workers who may be available to service the set of suborders 508 in the determined one or more timeslots. For example, the suborder timeslot data 510 may include two 10-minute timeslots (such as 2:30 PM-2:40 PM and 2:40 PM-2:50 PM). Also, the suborder timeslot data 510 may include a set of human workers (W₃, W₄, W₅, W₆, W₇, and W₈) who may be identified from the group of human workers 122.

The circuitry 202 may solve an optimization problem to determine an assignment for the set of suborders 508. The assignment may map the set or suborders 508 to the identified set of human workers (i.e., the human workers W₃, W₄, W₅, W₆, W₇, and W₈). The determination of the assignment may be such that a utilization of total hours available (i.e., 5+5+5+5+5+5 hours=30 hours) with the set of human workers to service the set of suborders may be above a threshold. As shown, for example, the circuitry 202 may determine the assignment information 512 which includes a mapping between the set or suborders 508 and the identified set of human workers (who may be assigned to service respective suborders from the set of suborders 508). In accordance with the assignment information 512, the suborder 1 may be assigned to the human worker W₃ for servicing the suborder 1 in 2:40 PM-2:50 PM timeslot. The suborder 2 may be assigned to the human worker W₄ for servicing the suborder 2 in 2:30 PM-2:40 PM and 2:40 PM-2:50 PM timeslots. The suborder 3 may be assigned to the human worker W₅ for servicing the suborder 3 in 2:30 PM-2:40 PM and 2:40 PM-2:50 PM timeslots. The suborder 4 may be assigned to the human worker W₆ for servicing the suborder 4 in 2:40 PM-2:50 PM timeslot. Similarly, the suborder 5 may be assigned to the human worker W₈ for servicing the suborder 5 in 2:40 PM-2:50 PM timeslot. It should be noted that the diagram 500 is presented merely as an example and should not be construed as limiting for the scope of the disclosure.

FIG. 6 is a diagram that illustrates an example user-interface of a worker device, in accordance with an embodiment of the disclosure. FIG. 6 is explained in conjunction with elements from FIG. 1, FIG. 2, FIG. 3, FIG. 4, and FIGS. 5A-5B. With reference to FIG. 6, there is shown a diagram 600 which includes a user-interface 602 of a first worker device (e.g., the first worker device 1082A). The user-interface (UI) 602 may be associated with the web client or a software application pre-installed on the first worker device 1082A. For example, the UI 602 may be associated with a human worker app pre-installed on the first worker device 1082A. The UI 602 may include a set of UI elements, such as a first set of UI elements 604, a second set of UI elements 606, and a third set of UI elements 608.

The first set of UI elements 604 may display a set of notifications that may be received by the first worker device 1082A from the system 102 directly, via the retail store management system 106 or via the store manager device 110. The set of notifications may include a first notification that includes the assignment of a first suborder (of the set of suborders of the customer order 314) mapped to the first human worker 122A and details associated with the first suborder. For example, the first notification may include an instruction to “Prepare Suborder 1 of Order ID: 1234” at 2:30 PM. The first notification may be associated with the servicing of the first suborder of the customer order 314 with the order ID “1234”. The first notification may further include a number of items in the suborder 1 (e.g., 4 items), a list of items in the suborder (e.g., a bread loaf, eggs, milk, and chocolate crème biscuit packets). The first notification may also include the pickup timeslot (e.g., “3:00 PM-3:30 PM”) at which the customer order 314 may be scheduled for pickup at the retail store 116. Also, the first notification may include a timeslot in which the suborder 1 needs to be serviced. For example, the timeslot to service the suborder 1 may be “2:40 PM-2:50 PM”.

The second set of UI elements 606 may be used to update order servicing details of a particular suborder of a customer order while the first human worker 122A may service the particular suborder. The second set of UI elements 606 may include a first UI element 606A, a second UI element 606B, a third UI element 606C, and a fourth UI element 606D. Each of the first UI element 606A and the second UI element 606B may include a dropdown list or a text box. Similarly, the third UI element 606C may include a set of radio buttons or a set of checkboxes. The fourth UI element 606D may include a button or a hyperlink. Through the first UI element 606A, the first worker device 1082A may receive a first user input indicative of an “order ID”. Through the second UI element 606B, the first worker device 1082A may receive a second user input which includes a suborder number or suborder ID for the order ID specified in the first user input. Through the third UI element 606C, the first worker device 1082A may receive a third user input which may be indicative of a selection of a status of the suborder specified in the second user input. Examples of the status of the suborder may include, but are not limited to, an “In Progress” status or a “Completed” status. At the start of or before servicing each suborder, the suborder may have a “Pending” status. Through the fourth UI element 606D, the first worker device 1082A may receive a fourth user input. Based on the fourth user input, the first worker device 1082A may update the suborder status of the selected suborder.

The third set of UI elements 608 may display an order fulfillment status of suborders of various orders that may have to be serviced or may have been already serviced by the first human worker 122A. For example, the third set of UI elements 608 may display a pending status for suborder 1 (associated with an order ID “1234”) and an in-progress status for suborder 2 (associated with an order ID “1233”). Also, the third set of UI elements 608 may display the status of both suborder 4 (associated with an order ID “1231”) and suborder 2 (associated with an order ID “1230”) as completed. It should be noted that the diagram 600 of FIG. 6 is presented merely as an example and should not be construed as limiting for the scope of the disclosure.

FIG. 7 is a diagram that illustrates an exemplary processing pipeline for training and use of a machine learning model for servicing time estimation, in accordance with an embodiment of the disclosure. FIG. 7 is explained in conjunction with elements from FIG. 1, FIG. 2, FIG. 3, FIG. 4, FIG. 5A, FIG. 5B, and FIG. 6. With reference to FIG. 7, there is shown a processing pipeline 700 of operations from 702 to 710 that describes training and use of a machine learning model for servicing time estimation. The operations 702 to 710 of the processing pipeline 700 may be executed by the system 102 of FIG. 1 or the circuitry 202 of FIG. 2.

At 702, a set of inputs may be received. In an embodiment, the circuitry 202 may be configured to receive the set of inputs from the retail store management system 106. As an example, the received set of inputs may include first historical data 712. The first historical data 712 may be associated with a first set of past customer orders associated with the retail store 116. The received first historical data 712 may include first information associated with a fulfillment of the first set of past customer orders. For a first past customer order of the first set of past customer orders, the first information may include, but not limited to, a size of each suborder in the first past customer order, a time duration to service each suborder of the first past customer order, and first identity information of first human workers who serviced suborders of the first past customer order.

At 704, it may be determined whether training of the one or more machine learning models 204A is required. In an embodiment, the circuitry 202 may be configured to determine whether the training of one or more machine learning models 204A is required based on a number of customer orders in the first set of past customer orders. In case the number of customer orders is less than a threshold (e.g., 1000 customer orders), the circuitry 202 may determine that the training of the one or more machine learning models 204A is not required. In such a case, control may pass to 402 f FIG. 4 and the circuitry 202 may be configured to execute the operations from 402 to 412 to determine the assignment of a set of suborders of a received customer order to a set of human workers (as described in FIG. 4). If the number of customer orders is determined to be greater than the threshold (e.g., 1000 customer orders), control may pass to 706.

At 706, a first machine learning model 714 of the one or more machine learning models 204A may be trained. In an embodiment, the circuitry 202 may be configured to train the one or more machine learning models 204A (which includes the first machine learning model 714) based on a determination that the training of the one or more machine learning models 204A is required. The first machine learning model 714 may be trained on the received set of inputs (which includes the first historical data 712) for servicing time estimation.

In an embodiment, the first set of past customer orders may be used to prepare a training dataset for the first machine learning model 714. The training dataset may include a set of features, such as, but not limited to, the size of each suborder of past customer orders, the time duration to service each of the suborders, and first identity information of the first human workers who serviced the suborders. The training dataset may include an output label, such as a servicing time duration associated with each of the suborders of the past customer orders. Examples of the one or more machine learning models 204A may include, but are not limited to, a support vector machine (SVM) model, an ensemble learning model, a regression model, a deep learning (DL) model based on artificial neural networks.

At 708, it may be determined whether accuracy of each of the one or more machine learning models 204A is above a threshold. In an embodiment, the circuitry 202 may be configured to determine whether the accuracy of each of the one or more machine learning models 204A is above the threshold (e.g., 90% or more). The accuracy may be determined based on a test dataset of past customer orders (prepared from the first set of past customer orders with output labels such as the servicing time duration). In case the accuracy determined for each of the one or more machine learning models 204A is less than the threshold (e.g., below 90%), control may pass to 706 and the one or more machine learning models 204A may be re-trained. In case the accuracy of a particular machine learning model (e.g., the first machine learning model 714 of the one or more machine learning models 204A) is above the threshold (e.g., 90% or above), control may pass to 710 and the particular machine learning model (e.g., the first machine learning model 714) may be selected for a service time estimation task (as described at 710).

In case the accuracy of each of the one or more machine learning models 204A is determined to be greater than the threshold, then the machine learning model with the highest accuracy may be selected for the service time estimation task. The selected machine learning model may be used for service time estimation, as described at 710. For example, if the accuracy of the SVM model and the DL model is 90% and 95%, respectively, then the machine learning model with the highest accuracy (i.e., the DL model) may be selected and used for the service time estimation (as described at 710).

In certain scenarios, even though the accuracy of one machine learning model (e.g., the first machine learning model 714) is above the threshold, the accuracy of another machine learning model (of the one or more machine learning models 204A) may be below the threshold. In such a case, the training of the machine learning model (whose accuracy is lower than the threshold) may continue. With the passage of time, a size of the first historical data 712 may increase with more customer orders. Based on the re-training of the machine learning model with initial lower accuracy using the first historical data 712 (of increased size), the accuracy of the machine learning model may increase. In case the increased accuracy crosses the threshold, the re-trained machine learning model may be used for the servicing time estimation task instead of the first machine learning model 714.

By way of example, and not limitation, initially the SVM model may have a higher accuracy than the DL model and may be selected for the servicing time estimation. The first historical data 712 may increase in size with more customer orders over time. When the accuracy of the SVM model crosses the threshold (e.g., 90%), then the SVM model may be selected for the servicing time estimation, as described at 710. Over time, as both the SVM model and the DL model are trained using the first historical data 712 (data size increased over time), the accuracy of the DL model may exceed the accuracy of the SVM model. For example, as the number of records of customer orders in the first historical data 712 grows to more than 10000 records, the accuracy of the DL model may cross 96%, while the accuracy of the SVM model may remain at 95% or less. In such a case, the DL model may be selected for the servicing time estimation, as described at 710.

In an embodiment, the one or more machine learning models 204A may be re-trained once a certain threshold number of new customer orders (e.g., 1000 new customer orders) may be added to the first historical data 712 or after every predetermined time duration, such as every week or every month. In such a case, control may pass to 706 for the re-training of the one or more machine learning models 204A.

At 710, a servicing time duration may be estimated. In an embodiment, the circuitry 202 may be configured to estimate a servicing time duration for each suborder of a set of suborders of a received customer order (e.g., the customer order 314), based on a trained machine learning model selected (at 708) for the servicing time estimation task. The trained machine learning model may be one of the one or more machine learning models 204A, such as the first machine learning model 714. The servicing time estimated by using the trained machine learning model may be used later on to determine the assignment for human workers of the retail store. For instance, after the servicing time may be estimated, control may pass to 404 of FIG. 4 and the circuitry 202 may be configured to execute the operations from 404 to 412 to determine the assignment of a set of suborders of a received customer order (as described in FIG. 4).

FIG. 8 is a diagram that illustrates another exemplary processing pipeline for training and use of a machine learning model for servicing time estimation, in accordance with an embodiment of the disclosure. FIG. 8 is explained in conjunction with elements from FIG. 1, FIG. 2, FIG. 3, FIG. 4, FIGS. 5A-5B, FIG. 6, and FIG. 7. With reference to FIG. 8, there is shown a processing pipeline 800 of operations from 802 to 810 that describes training and use of a machine learning model for servicing time estimation. The operations from 802 to 810 may be executed by the system 102 of FIG. 1 or the circuitry 202 of FIG. 2.

At 802, a set of inputs may be received. In an embodiment, the circuitry 202 may be configured to receive the set of inputs from the retail store management system 106.

As an example, the received set of inputs may include second historical data 812. The second historical data 812 may be associated with a second set of past customer orders associated with a first customer and the retail store 116. The received second historical data 812 may include second information associated with a fulfillment of the second set of past customer orders. For a second past customer order of the second set of past customer orders, the second information may include, for example, a size of each suborder in the second past customer order, a time duration to service each suborder of the second past customer order, second identity information of second human workers who serviced suborders of the second past customer order, and the like.

At 804, it may be determined whether training of the one or more machine learning models 204A is required. In an embodiment, the circuitry 202 may be configured to determine whether the training of one or more machine learning models 204A is required based on a number of customer orders in the second set of past customer orders. In case the number of customer orders is less than a threshold (e.g., 50 customer orders), the circuitry 202 may determine that the training of the one or more machine learning models 204A is not required. In such a case, control may pass to 702 of FIG. 7 and the circuitry 202 may be configured to execute the operations from 702 to 710 to train and use a machine learning model for servicing time estimation. Alternatively, in case the number of customer orders is less than the threshold, control may pass to 402 of FIG. 4 and the circuitry 202 may be configured to execute the operations from 402 to 412 to determine the assignment of a set of suborders of a received customer order to a set of human workers (as described in FIG. 4). If the number of customer orders in the second set of past customer orders is determined to be greater than the threshold (e.g., 50 customer orders), control may pass to 806.

At 806, a machine learning model (e.g., a second machine learning model 814 of the one or more machine learning models 204A) may be trained. In an embodiment, based on the determination that the training of the one or more machine learning models 204A may be required (as determined at 804), the circuitry 202 may be configured to train the one or more machine learning models 204A such as the second machine learning model 814. In an embodiment, the second machine learning model 814 may be trained on the received set of inputs (e.g., the second historical data 812). For example, the second set of past customer orders may be used to prepare a training dataset for the second machine learning model 814. The training dataset may include a set of features, such as, but not limited to, the size of each suborder of past customer orders in the second set of past customer orders, the time duration to service each of the suborders, and the second identity information of the second human workers who serviced the suborders. The training dataset may include an output label, such as a servicing time duration associated with each of the suborders of the past customer orders in the second set of past customer orders. Examples of the one or more machine learning models 204A may include, but are not limited to, a support vector machine (SVM) model, a regression model, an ensemble learning model, and a deep learning (DL) model based on artificial neural networks.

At 808, it may be determined whether accuracy of each of the one or more machine learning models 204A is above a threshold. In an embodiment, the circuitry 202 may be configured to determine whether the accuracy of each of the one or more machine learning models 204A is above the threshold (e.g., 90% accuracy). The accuracy may be determined based on a test dataset of past customer orders (prepared from the second set of past customer orders with known output labels, such as the servicing time duration associated with each suborder of the past customer orders. In case the accuracy determined for each of the one or more machine learning models 204A is lesser than the threshold (e.g., 90% accuracy), control may pass to 806 and the one or more machine learning models 204A may be re-trained. In case the accuracy of a particular machine learning model (e.g., the second machine learning model 814) is above the threshold (e.g., 90% accuracy), control may pass to 810 and the particular machine learning model (e.g., the second machine learning model 814) may be selected for a service time estimation task (as described at 810). For example, if the accuracy of an SVM model is greater than 90%, then the SVM model may be determined as trained for the service time estimation task and the SVM model may be used for the service time estimation.

In case the accuracy of each of the one or more machine learning models 204A is determined to be greater than the threshold, then the machine learning model with the highest accuracy may be selected for the service time estimation task. The selected machine learning model may be used for service time estimation, as described at 810. For example, if the accuracy of the SVM model and the DL model is 90% and 95%, respectively, then the machine learning model with the highest accuracy (i.e., the DL model) may be selected and used for the service time estimation (as described at 810).

In certain scenarios, even though the accuracy of one machine learning model (e.g., the second machine learning model 814) is above the threshold, the accuracy of another machine learning model (of the one or more machine learning models 204A) may be below the threshold. In such a case, the training of the machine learning model (whose accuracy is lower than the threshold) may continue. With the passage of time, size of the second historical data 812 may increase with more customer orders. Based on the re-training of the machine learning model (with initial lower accuracy) using the second historical data 812 (with increased size), the accuracy of the machine learning model may increase. In case the increased accuracy crosses the threshold, the re-trained machine learning model may be used for the servicing time estimation task instead of the second machine learning model 814.

By way of example, and not limitation, initially the SVM model may have a higher accuracy than the DL model and may be selected for the servicing time estimation. The second historical data 812 may increase in size with more customer orders over time. When the accuracy of the SVM model crosses the threshold (e.g., 90%), then the SVM model may be selected for the servicing time estimation, as described at 810. Over time, as both the SVM model and the DL model are trained using the second historical data 812 (data size increased over time), the accuracy of the DL model may exceed the accuracy of the SVM model. For example, as the number of records of customer orders in the second historical data 812 grow to more than 300 records, the accuracy of the DL model may cross 96%, while the accuracy of the SVM model may remain at 95% or less. In such a case, the DL model may be selected for the servicing time estimation, as described at 810.

In an embodiment, the one or more machine learning models 204A may be re-trained once a certain threshold number of new customer orders from the first customer (e.g., 15 new customer orders) may be added to the second historical data 812 or after every predetermined time duration, such as every week or every month.

At 810, a servicing time duration may be estimated. In an embodiment, the circuitry 202 may be configured to estimate the servicing time duration for each suborder of a set of suborders of a received customer order (e.g., the customer order 314), based on a trained machine learning model selected (at 808) for the servicing time estimation task. The trained machine learning model may be one of the one or more machine learning models 204A, such as the second machine learning model 814. The servicing time estimated by using the trained machine learning model may be used later on to determine the assignment for human workers of the retail store. For instance, after the servicing time may be estimated, control may pass to 404 of FIG. 4 and the circuitry 202 may be configured to execute the operations from 404 to 412 to determine the assignment of a set of suborders of a received customer order (as described in FIG. 4).

Though the disclosure is described with respect to a retail store, the scope of the disclosure may not be so limited. The disclosure may also be implemented in various other scenarios such as, but not limited to, a food take-away restaurant with multiple cuisines or menu options or a banking or financial institution with multiple departments.

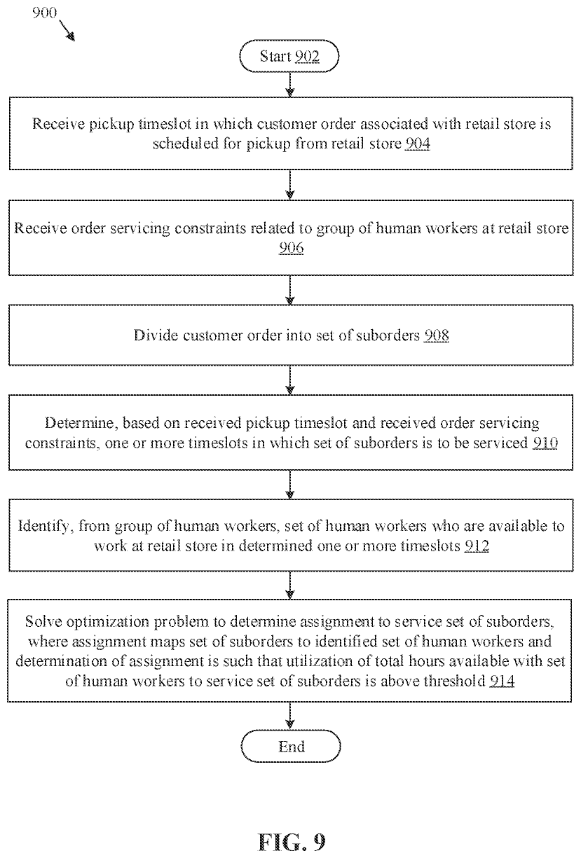

FIG. 9 is a flowchart that illustrates exemplary operations for fulfillment of orders scheduled for in-store pickup, in accordance with an embodiment of the disclosure. FIG. 9 is described in conjunction with elements from FIG. 1, FIG. 2, FIG. 3, FIG. 4, FIGS. 5A-5B, FIG. 6, FIG. 7, and FIG. 8. With reference to FIG. 9, there is shown a flowchart 900. The flowchart 900 may include operations 904 to 914 that may be implemented in the system 102. The flowchart 900 may start at 902 and proceed to 904.

At 904, the pickup timeslot may be received in which the customer order 314 associated with the retail store 116 may be scheduled for pickup from the retail store 116. In an embodiment, the circuitry 202 may be configured to receive the pickup timeslot in which the customer order 314 associated with the retail store 116 may be scheduled for pickup from the retail store 116. In an embodiment, the circuitry 202 may be configured to receive the customer order 314 for the in-store pickup at the retail store 116. The customer order 314 may be received from the customer device 104. Through the web client or the software application (which may be installed on the customer device 104), the customer device 104 may display a user-interface. The displayed user-interface may enable the customer 120 to place the customer order 314. Based on a user input through the displayed user-interface, the customer device 104 may generate the customer order. The customer order 314 may be indicative of the set of items purchased by the customer 120. The displayed user-interface may also enable the customer 120 to select the pickup timeslot from a set of timeslots available for pickup of the customer order from the retail store 116. In an embodiment, the circuitry 202 may recommend an earliest available timeslot and/or an optimum timeslot from the set of available timeslots to the customer 120 on the customer device 104. The optimum timeslot may be such that a pickup wait time for the customer 120 in this timeslot may be within a threshold. Further, the optimum timeslot may optimize a utilization of the group of human workers 122 of the retail store 116, such that the utilization may be above a utilization threshold. The customer device 104 may transmit the generated customer order 314 and the selected pickup timeslot for the customer order 314 to the system 102, via the communication network 112. The circuitry 202 may receive the transmitted customer order 314 and the pickup timeslot from the customer device 104.

At 906, the order servicing constraints 318 related to the group of human workers 122 at the retail store 116 may be received. In an embodiment, the circuitry 202 may be configured to receive the order servicing constraints 318 related to the group of human workers 122 at the retail store 116. The order servicing constraints 318 may be received from the retail store management system 106, which may retrieve the order servicing constraints 318 from the database 114 prior to transmission of the order servicing constraints 318 to the system 102. Details related to the received order servicing constraints 318 are provided further, for example, in FIG. 3.

At 908, the customer order 314 may be divided into the set of suborders. In an embodiment, the circuitry 202 may be configured to divide the customer order 314 into the set of suborders. The customer order 314 may be divided into the set of suborders based on the inventory information 320. The division of the customer order 314 is described further, for example, in FIG. 3.

At 910, based on the received pickup timeslot and the received order servicing constraints 318, the one or more timeslots in which the set of suborders may be serviced may be determined. In an embodiment, the circuitry 202 may be configured to determine the one or more timeslots in which the set of suborders may be serviced based on the received pickup timeslot and the received order servicing constraints 318. The determination of the one or more timeslots in which the set of suborders may be serviced is described further, for example, in FIG. 3.

At 912, from the group of human workers 122, the set of human workers may be identified. The identified set of human workers may be one or more human workers who may be available to work at the retail store 116 in the determined one or more timeslots. In an embodiment, the circuitry 202 may be configured to identify the set of human workers from the group of human workers 122. The identification of the set of human workers is described further, for example, in FIG. 3.

At 914, an optimization problem may be solved to determine the assignment to service the set of suborders of the customer order 314. The assignment may map the set of suborders to the identified set of human workers. Further, the determination of the assignment may be such that the utilization of the total hours available with the set of human workers to service the set of suborders may be above a threshold. In an embodiment, the circuitry 202 may be configured to solve the optimization problem. The solution of the optimization problem to determine the assignment is described further, for example, in FIG. 4. Control may pass to the end.

Although the flowchart 900 is illustrated as discrete operations, such as 904, 906, 908, 910, 912, and 914, the disclosure is not so limited. Accordingly, in certain embodiments, such discrete operations may be further divided into additional operations, combined into fewer operations, or eliminated, depending on the particular implementation without detracting from the essence of the disclosed embodiments.

Various embodiments of the disclosure may provide a non-transitory computer readable medium and/or storage medium having stored thereon, instructions executable by a machine and/or a computer to operate a system (for example, the system 102). The instructions may cause the system 102 to perform operations that include receiving a pickup timeslot in which a customer order (e.g., the customer order 314) associated with a retail store (e.g., the retail store 116) may be scheduled for pickup from the retail store 116. The operations may further include receiving order servicing constraints (e.g., the order servicing constraints 318) related to a group of human workers (e.g., the group of human workers 122) at the retail store 116. The operations may further include dividing the customer order 314 into a set of suborders. The operations may further include determining, based on the received pickup timeslot and the received order servicing constraints 318, one or more timeslots in which the set of suborders may be serviced. The operations may further include identifying, from the group of human workers 122, a set of human workers who may be available to work at the retail store 116 in the determined one or more timeslots. The operations may further include solving an optimization problem to determine an assignment to service the set of suborders. The assignment may map the set of suborders to the identified set of human workers. Further, the determination of the assignment may be such that a utilization of total hours available with the set of human workers to service the set of suborders may be above a threshold.

Exemplary aspects of the disclosure may provide a system (such as, the system 102 of FIG. 1) that includes circuitry (such as, the circuitry 202). The circuitry 202 may be configured to receive a pickup timeslot in which a customer order (e.g., the customer order 314) associated with a retail store (e.g., the retail store 116) may be scheduled for pickup from the retail store 116. The circuitry 202 may be further configured to receive order servicing constraints (e.g., the order servicing constraints 318) related to a group of human workers (e.g., the group of human workers 122) at the retail store 116. The circuitry 202 may be further configured to divide the customer order 314 into a set of suborders. The circuitry 202 may be further configured to determine, based on the received pickup timeslot and the received order servicing constraints 318, one or more timeslots in which the set of suborders may be serviced. The circuitry 202 may be further configured to identify, from the group of human workers 122, a set of human workers who may be available to work at the retail store 116 in the determined one or more timeslots. The circuitry 202 may be further configured to solve an optimization problem to determine an assignment to service the set of suborders. The assignment may map the set of suborders to the identified set of human workers. Further, the determination of the assignment may be such that a utilization of total hours available with the set of human workers to service the set of suborders may be above a threshold.

In an embodiment, the circuitry 202 may be further configured to receive inventory information (e.g., the inventory information 320) related to items sold by the retail store 116. The customer order 314 may be divided into the set of suborders based on the received inventory information 320. The inventory information 320 may include a database of items sold by the retail store 116. For each of the items, the database may include a unique product code or identifier, at least one of an item weight or an item volume, an item quantity, and a department to which a respective item may belong.

In an embodiment, the received order servicing constraints 318 may include, but is not limited to, a number of human workers who may be available to work in timeslots within a first period, and a number of hours each of the human workers may work in a day.

In an embodiment, the circuitry 202 may be further configured to estimate a servicing time duration for each suborder of the set of suborders. The circuitry 202 may be further configured to compute a reference time duration based on the estimated servicing time duration and a number of suborders included in the set of suborders. The circuitry 202 may be further configured to select parameters (e.g., the parameters 414) for a first objective function of the optimization problem based on the computed reference time duration and the estimated servicing time duration. The circuitry 202 may be further configured to select a vector of binary variables (e.g., the binary variable vector 416) for each human worker of the identified set of human workers. For a first human worker (e.g., the first human worker 122A) of the identified set of human workers, each binary variable in the vector of binary variables (e.g., the binary variable vector 416) may represent whether or not a respective suborder of the set of suborders may be assigned or mapped to the first human worker 122A. The circuitry 202 may be further configured to formulate the first objective function of the optimization problem, based on the selected vector of binary variables (e.g., the binary variable vector 416) and the selected parameters 414.

In an embodiment, the circuitry 202 may be further configured to determine a set of weights (e.g., the set of weights 418) for each human worker of the identified set of human workers, based on the estimated servicing time duration for each suborder of the set of suborders. For a first human worker (e.g., the first human worker 122A) of the identified set of human workers, each weight of the determined set of weights 418 may represent an extent by which a corresponding suborder of the set of suborders may be mappable or assignable to the first human worker 122A. The circuitry 202 may be further configured to formulate a second objective function, based on the selected vector of binary variables (e.g., the binary variable vector 416) and the determined set of weights 418. The circuitry 202 may be further configured to solve the formulated first objective function and the formulated second objective function to generate a binary solution (e.g., the binary solution 420) of the optimization problem. The generated binary solution 420 may include a vector of binary values of the selected vector of binary variables (e.g., the binary variable vector 416). The assignment may be determined based on the generated binary solution 420. In an embodiment, for each suborder of the set of suborders, the servicing time duration may be a median time duration that may be estimated based on a size of a respective suborder of the set of suborders.

In an embodiment, first historical data (e.g., the first historical data 712) of a first set of past customer orders associated with the retail store 116 may be received. A first machine learning model (e.g., the first machine learning model 714) may be trained based on the received first historical data 712. The servicing time duration for each suborder of the set of suborders may be estimated further using the trained first machine learning model 714. The received first historical data 712 may include first information associated with a fulfillment of the first set of past customer orders. For a first past customer order of the first set of past customer orders, the first information may include, but is not limited to. a size of each suborder in the first past customer order, a time duration to service each suborder of the first past customer order, and first identity information of first human workers who serviced suborders of the first past customer order.

In an embodiment, second historical data (e.g., the second historical data 812) of a second set of past customer orders associated with a first customer and the retail store 116 may be received. A second machine learning model (e.g., the second machine learning model 814) may be trained based on the received second historical data 812. The servicing time duration for each suborder of the set of suborders may be estimated further using the trained second machine learning model 814. The received second historical data 812 may include second information associated with a fulfillment of the second set of past customer orders. For a second past customer order of the second set of past customer orders, the second information may include, but is not limited to, a size of each suborder in the second past customer order, a time duration to service each suborder of the second past customer order, and second identity information of second human workers who serviced suborders of the second past customer order.

The circuitry 202 may be further configured to control a first electronic device (e.g., the first worker device 1082A) associated with a first human worker (e.g., the first human worker 122A) of the identified set of human workers, to display a first notification based on the assignment. The first notification may include a first suborder of the set of suborders mapped to the first human worker and details associated with the first suborder.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted to carry out the methods described herein may be suited. A combination of hardware and software may be a general-purpose computer system with a computer program that, when loaded and executed, may control the computer system such that it carries out the methods described herein. The present disclosure may be realized in hardware that comprises a portion of an integrated circuit that also performs other functions.

The present disclosure may also be embedded in a computer program product, which comprises all the features that enable the implementation of the methods described herein, and which when loaded in a computer system is able to carry out these methods. Computer program, in the present context, means any expression, in any language, code or notation, of a set of instructions intended to cause a system with information processing capability to perform a particular function either directly, or after either or both of the following: a) conversion to another language, code, or notation; b) reproduction in a different material form.

While the present disclosure is described with reference to certain embodiments, it will be understood by those skilled in the art that various changes may be made, and equivalents may be substituted without departure from the scope of the present disclosure. In addition, many modifications may be made to adapt a particular situation or material to the teachings of the present disclosure without departure from its scope. Therefore, it is intended that the present disclosure is not limited to the particular embodiment disclosed, but that the present disclosure will include all embodiments that fall within the scope of the appended claims.

1. A system, comprising:
circuitry configured to:
receive a pickup timeslot in which a customer order associated with a retail store is scheduled for pickup from the retail store;
receive order servicing constraints related to a group of human workers at the retail store;
divide the customer order into a set of suborders based on a set of items in the customer order;
determine, based on the received pickup timeslot and the received order servicing constraints, one or more timeslots in which the set of suborders is to be serviced;
identify, from the group of human workers, a set of human workers who are available to work at the retail store in the determined one or more timeslots;
estimate a servicing time duration for each suborder of the set of suborders;
compute a reference time duration based on the estimated servicing time duration and a number of suborders included in the set of suborders;
solve an optimization problem to determine an assignment to service the set of suborders, wherein
the assignment maps the set of suborders to the identified set of human workers,
the determination of the assignment is such that a utilization of total hours that is available with the set of human workers to service the set of suborders is above a threshold value of the utilization of the total hours, and
the determination of the assignment is such that a total absolute deviation from the computed reference time duration for all human workers in the identified set of human workers is minimized; and
control an electronic device associated with a human worker of the identified set of human workers, to display a notification based on the assignment, wherein
the notification comprises a suborder of the set of suborders and details associated with the suborder, and
the suborder is mapped to the human worker.

2. The system according to claim 1, wherein the circuitry is further configured to receive inventory information related to items sold by the retail store, and wherein the customer order is divided into the set of suborders based on the received inventory information.

3. The system according to claim 2, wherein the inventory information comprises a database of items sold by the retail store, and
wherein, for each of the items, the database comprises a unique product code or identifier, at least one of an item weight or an item volume, an item quantity, and a department to which a respective item belongs.

4. The system according to claim 1, wherein the received order servicing constraints comprises:
a number of human workers who are available to work in timeslots within a first period, and a number of hours each of the group of human workers works in a day.

5. The system according to claim 1, wherein the circuitry is further configured to:
select parameters for a first objective function of the optimization problem based on the computed reference time duration and the estimated servicing time duration;
select a vector of binary variables for each human worker of the identified set of human workers,
wherein, for a first human worker of the identified set of human workers, each binary variable in the vector of binary variables represents whether or not
a respective suborder of the set of suborders is to be assigned or mapped to the first human worker; and
formulate the first objective function of the optimization problem based on the selected vector of binary variables and the selected parameters.

6. The system according to claim 5, wherein the circuitry is further configured to:
determine a set of weights for each human worker of the identified set of human workers, based on the estimated servicing time duration for each suborder of the set of suborders,
wherein, for a first human worker of the identified set of human workers, each weight of the determined set of weights represents an extent by which a corresponding suborder of the set of suborders is mappable or assignable to the first human worker;
formulate a second objective function of the optimization problem based on the selected vector of binary variables and the determined set of weights; and
solve the formulated first objective function and the formulated second objective function to generate a binary solution of the optimization problem, wherein
the generated binary solution includes a vector of binary values of the selected vector of binary variables, and
the assignment is determined based on the generated binary solution.

7. The system according to claim 5, wherein, for each suborder of the set of suborders, the servicing time duration is a median time duration that is estimated based on a size of a respective suborder of the set of suborders.

8. The system according to claim 5, wherein the circuitry is further configured to:
receive first historical data of a first set of past customer orders associated with the retail store; and
train a first machine learning model based on the received first historical data,
wherein the servicing time duration for each suborder of the set of suborders is estimated further using the trained first machine learning model.

9. The system according to claim 8, wherein received first historical data comprises first information associated with a fulfillment of the first set of past customer orders, and
wherein, for a first past customer order of the first set of past customer orders, the first information comprises a size of each suborder in the first past customer order, a time duration to service each suborder of the first past customer order, and first identity information of first human workers who serviced suborders of the first past customer order.

10. The system according to claim 8, wherein the circuitry is further configured to:
receive second historical data of a second set of past customer orders associated with a first customer and the retail store;
train a second machine learning model based on the received second historical data,
wherein the servicing time duration for each suborder of the set of suborders is estimated further using the trained second machine learning model.

11. The system according to claim 10, wherein the received second historical data comprises second information associated with a fulfillment of the second set of past customer orders, and
wherein, for a second past customer order of the second set of past customer orders, the second information comprises a size of each suborder in the second past customer order, a time duration to service each suborder of the second past customer order, and second identity information of second human workers who serviced suborders of the second past customer order.

12. (canceled)

13. A method, comprising:
receiving a pickup timeslot in which a customer order associated with a retail store is scheduled for pickup from the retail store;
receiving order servicing constraints related to a group of human workers at the retail store;
dividing the customer order into a set of suborders based on a set of items in the customer order;
determining, based on the received pickup timeslot and the received order servicing constraints, one or more timeslots in which the set of suborders is to be serviced;
identifying, from the group of human workers, a set of human workers who are available to work at the retail store in the determined one or more timeslots;
estimating a servicing time duration for each suborder of the set of suborders;
computing a reference time duration based on the estimated servicing time duration and a number of suborders included in the set of suborders;
solving an optimization problem to determine an assignment to service the set of suborders, wherein
the assignment maps the set of suborders to the identified set of human workers,
the determination of the assignment is such that a utilization of total hours that is available with the set of human workers to service the set of suborders is above a threshold value of the utilization of the total hours, and
the determination of the assignment is such that a total absolute deviation from the computed reference time duration for all human workers in the identified set of human workers is minimized; and
controlling an electronic device associated with a human worker of the identified set of human workers, to display a notification based on the assignment, wherein
the notification comprises a suborder of the set of suborders and
details associated with the suborder, and
the suborder is mapped to the human worker.

14. The method according to claim 13, further comprising receiving inventory information related to items sold by the retail store,
wherein the customer order is divided into the set of suborders based on the received inventory information.

15. The method according to claim 14, wherein the inventory information comprises a database of items sold by the retail store, and
wherein, for each of the items, the database comprises a unique product code or identifier, at least one of an item weight or an item volume, an item quantity, and a department to which the respective item belongs.

16. The method according to claim 13, wherein the received order servicing constraints comprises:
a number of human workers who are available to work in timeslots within a first period, and
a number of hours each of the group of human workers works in a day.

17. The method according to claim 13, further comprising:
selecting parameters for a first objective function of the optimization problem based on the computed reference time duration and the estimated servicing time duration;
selecting a vector of binary variables for each human worker of the identified set of human workers,
wherein, for a first human worker of the identified set of human workers, each binary variable in the vector of binary variables represents whether or not a respective suborder of the set of suborders is to be assigned or mapped to the first human worker; and
formulating the first objective function of the optimization problem based on the selected vector of binary variables and the selected parameters.

18. The method according to claim 17, further comprising:
determining a set of weights for each human worker of the identified set of human workers, based on the estimated servicing time duration for each suborder of the set of suborders,
wherein, for a first human worker of the identified set of human workers, each weight of the determined set of weights represents an extent by which a
corresponding suborder of the set of suborders is mappable or assignable to the first human worker;
formulating a second objective function of the optimization problem based on the selected vector of binary variables and the determined set of weights; and
solving the formulated first objective function and the formulated second objective function to generate a binary solution of the optimization problem, wherein
the generated binary solution includes a vector of binary values of the selected vector of binary variables, and
the assignment is determined based on the generated binary solution.

19. (canceled)

20. A non-transitory computer-readable medium having stored thereon, computer-executable instructions that when executed by a system, causes the system to execute operations, the operations comprising:
receiving a pickup timeslot in which a customer order associated with a retail store is scheduled for pickup from the retail store;
receiving order servicing constraints related to a group of human workers at the retail store;
dividing the customer order into a set of suborders based on a set of items in the customer order;
determining, based on the received pickup timeslot and the received order servicing constraints, one or more timeslots in which the set of suborders is to be serviced;
identifying, from the group of human workers, a set of human workers who are available to work at the retail store in the determined one or more timeslots;
estimating a servicing time duration for each suborder of the set of suborders;
computing a reference time duration based on the estimated servicing time duration and a number of suborders included in the set of suborders;
solving an optimization problem to determine an assignment to service the set of suborders, wherein
the assignment maps the set of suborders to the identified set of human workers,
the determination of the assignment is such that a utilization of total hours that is available with the set of human workers to service the set of suborders is above a threshold value of the utilization of the total hours, and
the determination of the assignment is such that a total absolute deviation from the computed reference time duration for all human workers in the identified set of human workers is minimized; and
controlling an electronic device associated with a human worker of the identified set of human workers, to display a notification based on the assignment, wherein
the notification comprises a suborder of the set of suborders and details associated with the suborder, and
the suborder is mapped to the human worker.
